(19) United States
(12) Patent Application Publication
(10) Pub. No.: US 2026/0094096 A1
(43) Pub. Date: Apr. 2, 2026

(54) METHOD AND DEVICE FOR PROVIDING PERSONALIZED WORK INFORMATION

(71) Applicants: Samsung SDS Co., Ltd., Seoul (KR); Korea Advanced Institute of Science and Technology, Daejeon (KR)

(72) Inventors: Jung A LEE, Seoul (KR); Moon Young Kwon, Seoul (KR); Yun Kyung Kim, Seoul (KR); Evelyn Min Kyung Lee, Seoul (KR); Sung Jin Hong, Seoul (KR); Dae Shik Kim, Daejeon (KR)

(73) Assignees: Samsung SDS Co., Ltd, Seoul (KR); Korea Advanced Institute of Science and Technology, Daejeon (KR)

(21) Appl. No.: 19/250,844

(22) Filed: Jun. 26, 2025

(30) Foreign Application Priority Data
Sep. 27, 2024 (KR) 10-2024-0131648
Oct. 31, 2024 (KR) 10-2024-0151792

(51) Int. Cl. G06Q 10/0633; G06F 9/451

(52) U.S. Cl. CPC G06Q 10/0633; G06F 9/451

(57) ABSTRACT

A method for providing personalized task information is provided. The method according to some embodiments may include identifying, by a computing device, a task list including a first task and at least one module required to perform the first task, based on first information including task system data of a first user; generating, by the computing device, customized detailed information for the at least one module, based on second information including experience of the first user; and automatically generating, by the computing device, a user-customized UI based on the task list, the at least one module, and the customized detailed information.

### CROSS-REFERENCE TO RELATED APPLICATION(S)

This application claims priority from Korean Patent Application No. 10-2024-0131648 filed on Sep. 27, 2024, and Korean Patent Application No. 10-2024-0151792 filed on Oct. 31, 2024, in the Korean Intellectual Property Office, and all the benefits accruing therefrom under 35 U.S.C. 119, the contents of which in its entirety are herein incorporated by reference.

### BACKGROUND

### Field

The present disclosure relates to a method and device for providing personalized work information. More specifically, the present disclosure relates to a technology for improving work efficiency by generating a work list to be performed by a user based on work system data and personal experience information of the user, recommending a module necessary for performing the work, and providing user-customized detailed information and UI based on the recommended module.

### Description of Related Art

Conventional work management systems generally has a scheme in which a user directly searches for necessary information or manually manages a work list. Since such a system does not consider the user's personal experience, proficiency, work environment, etc., there is a limitation in that it provides the same information uniformly and thus does not satisfy the user's individual needs. In particular, in the case of inexperienced users or new employees, a lot of time and effort is required to find the necessary data or related personnel, thereby degrading work efficiency.

Recently, with the development of artificial intelligence (AI) technology, generative AI (Gen AI) and Retrieval-Augmented Generation (RAG) technologies have been introduced into the work information providing system. However, since such technology is also mainly focused on individual data search, there is a limit to providing necessary information in a user-customized manner according to the user's personal work context or providing the same in an optimized UI according to the importance of information. As a result, the accessibility and efficiency of information required for work are reduced, and information consistency and continuity are insufficient.

In addition, due to information distributed across various systems and channels, a user has to switch between various work systems and retrieve data, and in this process, work efficiency is greatly reduced. In fact, it takes a considerable amount of time for a user to check the necessary data and information before starting the work, and duplicate information search and repetitive login occur while alternately using several work tools with each other.

Therefore, there is a need for a technology that preemptively provides necessary information according to the user's experience, proficiency, and work environment, and configures information into an optimized UI based on the amount and importance of the information and provides the same to the user.

### Prior Art Literature

### Patent Document

(Patent Document 0001) Korean Patent No. 10-1782534 (Registration Date 2017.09.21)

### SUMMARY

The present disclosure is set forth to aim to solve the problem that the conventional system cannot provide the user-customized work information according to the user's individual experience and proficiency. Since the traditional work management system provides the same information to all users uniformly, the system may not consider that necessary information varies according to the user's experience and work skill. In particular, users with little experience or new employees are likely to miss even essential information, while skilled users are provided with excessive unnecessary information, resulting in a problem of deteriorating work efficiency. This situation reduces information accessibility and makes it impossible for the users to easily obtain desired work information.

In addition, since information required for work is distributed across several work systems and channels, a user has to directly search for necessary data using various work tools. Before work begins, it takes a considerable amount of time to prepare related data, and the process of logging in various systems and searching for data between various systems is repeated. This allows users to spend unnecessary time switching between multiple tools and interfaces before focusing on important works, thereby not only hindering continuity and consistency of work, but also lowering overall work efficiency. This leads to data disconnection and lack of consistency as caused by information distributed across multiple systems, and disrupts the flow of information and negatively affects work performance.

In addition, the conventional generative AI-based work management system has a limitation in that all users should use the same UI regardless of the amount and importance of information. Although it is necessary to provide information in a form varying depending on the amount and importance of the information, such a system provides a uniform UI configuration so that the user may not easily and intuitively understand the information. For example, when both simple information and complex information are provided in the same interface, it is difficult to grasp the importance of information at a glance and it is difficult for a user to quickly find necessary information. This not only degrades the user experience, but may also lead to confusion in situations where important work information should be immediately checked.

Accordingly, the present disclosure is intended to provide a system and method to enable intuitive and efficient information access by providing user-customized information according to a user's work experience and proficiency, integrating and managing distributed data with each other, and providing an UI optimized based on the amount and importance of information. Accordingly, the method and system of the present disclosure makes it possible to more easily obtain information required by a user and maximize work efficiency by providing user-customized information that meets individual needs.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims and combinations thereof.

According to some embodiments of the present disclosure, there is provided a method performed by a computing device, the method comprising: identifying, based on first information including task system data of a first user, a task list including a first task and at least one module required to perform the first task; generating, based on second information including experience of the first user, customized detailed information for the at least one module; and automatically generating a user-customized UI based on the task list, the at least one module, and the customized detailed information.

In some embodiments, the task list and the at least one module are updated in real time based on updates to the first information, and the customized detailed information is updated in real time based on updates to the second information.

In some embodiments, the first information further includes task system data of a second user different from the first user, and the second information further includes experience of the second user different from the first user. The task list and the at least one module are updated in real time based on updates to the first information, and the customized detailed information is updated in real time based on updates to the second information.

In some embodiments, the method further comprises: determining, based on the first information and the second information, whether the user-customized UI needs to be updated; and when it is determined that an update is needed, performing the update of the user-customized UI.

In some embodiments, identifying the task list and the at least one module comprises: identifying a task list including the first task based on the first information; reviewing the necessity of a module related to the first task based on the first information; and identifying at least one module required to perform the first task based on the review result.

In some embodiments, generating the customized detailed information for the at least one module comprises: analyzing the second information including the experience of the first user; identifying the customized detailed information for the at least one module based on the analysis result; and generating the identified detailed information.

In some embodiments, automatically generating the user-customized UI comprises: exploring an optimal UI; generating a design based on the explored UI; generating a first task card including the design; receiving feedback on user satisfaction with the first task card; and generating a second task card based on the feedback.

According to another embodiment of the present disclosure, there is provided a personalized task information providing apparatus comprising: at least one processor; and a memory storing a computer program executable by the at least one processor, wherein when executed, the at least one processor: identifies, based on first information including task system data of a first user, a task list including a first task and at least one module required to perform the first task; generates, based on second information including experience of the first user, customized detailed information for the at least one module; and automatically generates a user-customized UI based on the task list, the at least one module, and the customized detailed information.

In some embodiments, the task list and the at least one module are updated in real time based on updates to the first information, and the customized detailed information is updated in real time based on updates to the second information.

In some embodiments, the first information further includes task system data of a second user different from the first user, and the second information further includes experience of the second user different from the first user. The task list and the at least one module are updated in real time based on updates to the first information, and the customized detailed information is updated in real time based on updates to the second information.

In some embodiments, the at least one processor determines whether an update to the user-customized UI is needed based on the first information and the second information, and performs the update of the user-customized UI when it is determined that an update is needed.

In some embodiments, identifying the task list and the at least one module comprises: identifying a task list including the first task based on the first information; reviewing the necessity of a module related to the first task based on the first information; and identifying at least one module required to perform the first task based on the review result.

In some embodiments, generating the customized detailed information for the at least one module comprises: analyzing the second information including the experience of the first user; identifying the customized detailed information for the at least one module based on the analysis result; and generating the identified detailed information.

In some embodiments, automatically generating the user-customized UI comprises: exploring an optimal UI; generating a design based on the explored UI; generating a first task card including the design; receiving feedback on user satisfaction with the first task card; and generating a second task card based on the feedback.

According to another embodiment of the present disclosure, there is provided a computer program stored in a computer-readable medium and coupled to a computing device, the computer program including operations of: identifying, based on first information including task system data of a first user, a task list including a first task and at least one module required to perform the first task; generating, based on second information including experience of the first user, customized detailed information for the at least one module; and automatically generating a user-customized UI based on the task list, the at least one module, and the customized detailed information.

Specific details of other embodiments are included in the detailed description and drawings.

### BRIEF DESCRIPTION OF DRAWINGS

The above and other aspects and features of the present disclosure will become more apparent by describing in detail illustrative embodiments thereof with reference to the attached drawings, in which:

FIG. 1 is a diagram illustrating a configuration of an entirety of a system in which personalized work information is provided according to an embodiment of the present disclosure;

FIG. 2 is a diagram illustrating a conventional work processing process according to an embodiment of the present disclosure;

FIG. 3 is a diagram illustrating a configuration of a AI platform for recommending a personalized work according to an embodiment of the present disclosure;

FIG. 4 is a diagram illustrating a configuration of an entirety of a system in which the personalized work recommendation AI platform of the present disclosure interacts with various components to provide user-customized work information optimized for a user;

FIG. 5 is a diagram illustrating an analysis/recommendation unit in a personalized work recommendation AI platform;

FIG. 6 is a diagram illustrating a generation unit in a personalized work recommendation AI platform;

FIG. 7 is a diagram illustrating an AI design unit in a personalized work recommendation UI platform;

FIG. 8 is a flowchart illustrating an analysis or recommendation process in relation to an analysis/recommendation unit;

FIG. 9 is a diagram for illustrating sub-work of a hierarchical structure in relation to a work performance procedure;

FIG. 10 is a diagram illustrating a use case of an analysis/recommendation unit according to an embodiment of the present disclosure;

FIG. 11 is a diagram illustrating another use case of an analysis/recommendation unit according to an embodiment of the present disclosure;

FIG. 12 is a diagram illustrating still another use case of the analysis/recommendation unit according to an embodiment of the present disclosure;

FIG. 13 is a flowchart illustrating a process of generating detailed information in relation to a generation unit according to an embodiment of the present disclosure;

FIG. 14 is a diagram illustrating a use case of a generation unit according to an embodiment of the present disclosure;

FIG. 15 is a diagram illustrating another use case of a generation unit according to an embodiment of the present disclosure;

FIG. 16 is a flowchart illustrating a process of generating a work card in relation to an UI design unit according to an embodiment of the present disclosure;

FIG. 17 is a view illustrating a process of generating a work card required for performing a work at different levels based on user skill levels, in an example of using an UI design unit according to an embodiment of the present disclosure;

FIG. 18 is a flowchart illustrating an entirety of a process of providing personalized work information according to an embodiment of the present disclosure;

FIG. 19 is a flowchart illustrating detailed steps of step S1810 according to an embodiment of the present disclosure;

FIG. 20 is a flowchart illustrating detailed steps of step S1820 according to an embodiment of the present disclosure;

FIG. 21 is a flowchart illustrating detailed steps of step S1830 according to an embodiment of the present disclosure; and

FIG. 22 is a block diagram illustrating a hardware configuration of a computing device for providing personalized work information according to an embodiment of the present disclosure.

### DETAILS DESCRIPTIONS

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In describing this disclosure, specific descriptions of relevant disclosed configurations or features are omitted where it is believed that such detailed descriptions would obscure the essence of the invention.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure.

In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms.

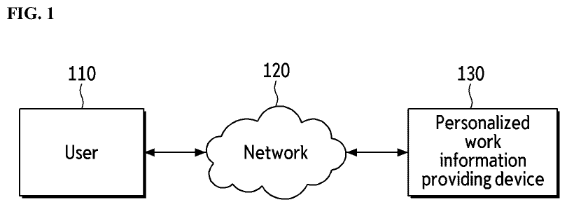

FIG. 1 is a diagram illustrating a configuration of an entirety of a system in which personalized work information is provided according to an embodiment of the present disclosure.

Referring to FIG. 1, the entirety of the system in which personalized work information is provided may include a user 110, a network 120, and a personalized work information providing device 130.

The user 110 is a subject receiving personalized work information, and serves to generate work system data and request necessary information based on the data. The user 110 may request various work information based on personal information such as work experience, proficiency, preference, and the like, and appropriate user-customized information is provided according to such request. The user 110 may interact with the system via a computing device, and may communicate with the information providing device 130 via the network 120 using a device, such as a desktop computer, a mobile device, a tablet, or the like.

The network 120 serves to connect the user 110 and the personalized work information providing device 130 to each other, and supports data transmission therebetween. Data requested from the user 110 may be transmitted to the personalized work information providing device 130 through the network 120, and response information to the request may be transmitted to the user 110 again through the network 120. The network 120 may transmit and receive data in various communication schemes, and this data transmission may also include data transmission in a cloud environment or a local network. For example, the network 120 may be embodied as any kind of wired/wireless network such as a Local region Network (LAN), a Wide region Network (WAN), a mobile radio communication network, or a Wireless Broadband Internet.

The personalized work information providing device 130 collects and analyzes the work data of the user 110 to generate and provide user-customized work information optimized for the user. In relation to the user 110, the device 130 automatically recommends information, modules, and guidelines necessary for performing the work based on various data, and provides an appropriate UI according to the importance and amount of information. The personalized work information providing device 130 may provide the user-customized information to the user using various artificial intelligence (AI) algorithms and user profiling technologies, and may update information according to a user's request in real time.

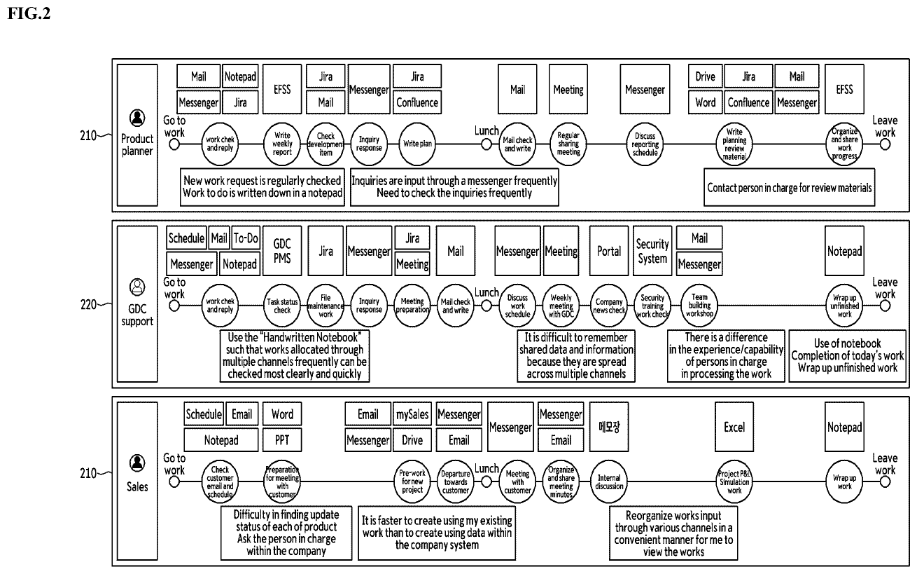

FIG. 2 is a diagram illustrating a conventional work processing process according to an embodiment of the present disclosure.

FIG. 2 shows an example in which work processes in each department and a person in charge are separated from each other and an inefficient information search procedure is generated accordingly, and thus shows a problem in that it takes a lot of time to access work information required by the user. FIG. 2 shows the separate work processes related to three roles, that is, a product planner 210, an GDC support 220, and a sales 230, respectively, and specifically describes problems caused by the inefficient processes along with the main work flows they experience.

When a new work occurs or a new work is identified through a weekly meeting, the product planner 210 faces a problem of searching using various systems in the process of finding and organizing related data. The planner should collect information through various channels such as mail, Jira, messenger, and EFSS, and goes through the process of recording the new work in a notepad whenever the new work occurs. In addition, there is a situation in which when inquiries are received via the messenger from time to time, the product planner has to check and respond to the contents input to the messenger one by one. For example, in order to prepare the necessary data during the planning meeting, the product planner should individually find the data in the mail or messenger, and should additionally contact the person in charge to supplement insufficient information to obtain the data. Thus, it takes excessive time and effort.

The GDC support 220 has difficulty in checking and updating information through multiple channels while performing a specific work. The GDC support personnel should check various work-related information through e-mail, messenger, Jira, and PMS systems, and should identify information related to new requests from time to time through multiple channels. In this process, the shared data and information are distributed over several channels, thereby causing a problem that is difficult to remember the same. For example, the GDC support 220 should collect and organize the data in the e-mail, PMS, messenger, etc. while processing requests with customers. This means that it takes a lot of time to find information and the flow of the work is often cut off.

The sales 230 has a situation in which it is necessary to search for data in various in-house systems mainly for meeting preparation with customers and data update, and to integrate the same with each other. In particular, since necessary data is distributed across several systems, each system should be accessed one by one to find information, and it is difficult to respond to frequently updated information. For example, in order to find the data required by each customer, it is necessary to collect and organize data using Word, Excel, mail, and drive, and this process consumes excessive time. In addition, there is a problem in that work efficiency is greatly reduced because the work of integrating and managing information distributed over multiple channels should be repeatedly performed.

Accordingly, FIG. 2 shows that inefficient processes are becoming obstacles to work performance in the main work stages performed by each role. The information required for each role should be found in several systems, and it takes a lot of time to collect and organize distributed information. Thus, there is a problem in that the continuity of work is deteriorated and work efficiency is lowered.

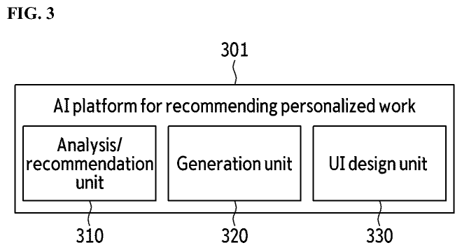

FIG. 3 is a diagram illustrating a configuration of a AI platform for recommending personalized work according to an embodiment of the present disclosure.

An AI platform 301 for recommending personalized work is largely divided into an analysis/recommendation unit 310, a generation unit 320, and a UI design unit 330, and each unit may perform a main function for providing user-customized work information to a user.

The analysis/recommendation unit 310 may analyze and recommend necessary work information based on data input from the user. The analysis/recommendation unit 310 may collect various information such as the user's work history, work proficiency, and personal preference and preemptively propose a module related to a work process most suitable for the user based on the collected information. For example, the analysis/recommendation unit 310 may provide, to a new user, a work recommendation including basic information and procedures, and provide more advanced information and specialized data to an experienced user, thereby helping the user to increase work efficiency.

The generation unit 320 may generate detailed information suitable for each user's request based on the work module and process recommended by the analysis/recommendation unit 310. The generation unit 320 may automatically generate data required by the user in consideration of the user's experience, skills, and currently in progress projects, thereby providing user-customized information updated in real time. For example, when the user performs a research work, the generation unit 320 may generate the latest trend data, related cases, references, and the like, and provide them to the user.

The UI design unit 330 may provide an optimal UI to the user based on the data provided by the analysis/recommendation unit 310 and the generation unit 320. The UI design unit 330 automatically designs an appropriate interface based on the amount and importance of information, thereby helping the user to easily check and utilize the information. For example, the UI design unit 330 may prove information on simple work in a form of a card, and configure information requiring a complicated procedure into a step-by-step UI and provide the UI to a user, such that the user-customized interface is provided to the user, thereby increasing the accessibility to and efficiency of information.

Accordingly, the AI platform 301 as illustrated in FIG. 3 is a system capable of integrally performing a series of processes of collecting and analyzing user's work data to recommend and generate the optimized user-customized information, and, configuring and providing the UI that helps the user to efficiently perform the work based on the optimized user-customized information.

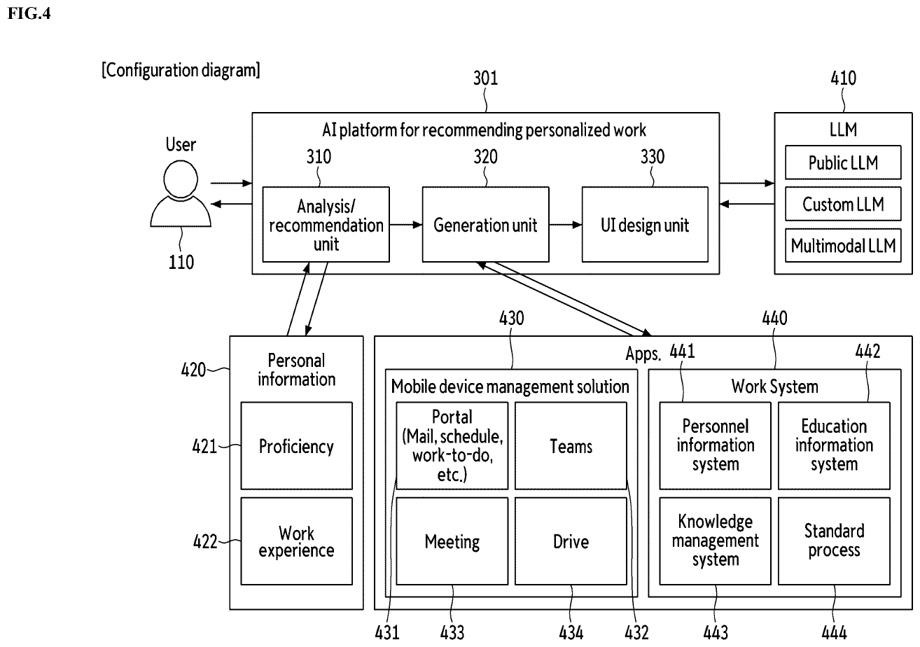

FIG. 4 is a diagram illustrating a configuration of an entirety of a system in which the personalized work recommendation AI platform 301 of the present disclosure interacts with various components to provide user-customized work information optimized for a user.

The user 110 may perform a work based on the content provided from the personalized work recommendation AI platform. In this case, the user 110 may directly interact with the personalized work recommendation AI platform 301 and input his/her own work data and requirements thereto. The user inputs personal information 420 such as his or her proficiency 421 and a work experience 422 into the personalized work recommendation AI platform so that the user-customized information may be provided from the AI platform to the user. The personalized work recommendation AI platform provides user-customized recommendation information based on the user's personal information and helps the user to handle his or her work more efficiently through the user-customized UI. The user can intuitively perform the work through the user-customized AI provided from the personalized work recommendation UI platform, and may receive step-by-step guidance on the work procedures therefrom, such that unnecessary search processes can be reduced and work efficiency can be improved. For example, when data required for a specific work are scattered across several systems, the personalized work recommendation AI platform integrates the data with other and provides the integrated data on the user-customized UI, thereby reducing data search and access time.

The personalized work recommendation AI platform 301 is connected to a LLM 410, so that advanced user-customized information may be provided through various large-scale language models. The LLM 410 includes Public LLM, Custom LLM, Multimodal LLM, and the like, and each of the LLM models may provide optimized information according to a user's request. The Public LLM may provide an answer to a general question through an open language model, and the Custom LLM may learn data specialized on a specific domain to provide user-customized information. The Multimodal LLM may process various data forms such as images and audio as well as text to provide more diverse information formats to the user. For example, when a user needs to utilize visual data or voice data as well as project-related data, the Multimodal LLM may analyze the data and recommend related information.

In addition, the personalized work recommendation AI platform 301 is closely related to the user personal information 420, and the personal information 420 is composed of the user's proficiency 421 and work experience 422. The proficiency 421 indicates how familiar and proficient the user is with and in a specific work or skill, and the work experience 422 includes the work history performed by the user and project experience of the user. The personal information 420 may be utilized in the analysis/recommendation unit 310, the generation unit 320, and the AI design unit 330 of the personalized work recommendation UI platform to be used to provide user-customized information. In particular, the analysis/recommendation unit 310 preemptively recommends a work module and data required by the user based on the personal information 420, and plays an important role in designing a user-customized process. For example, basic materials and step-by-step guides are provided to less-skilled users, and advanced materials and advanced analysis information are provided to experienced users to support more efficient work processing.

The APPS 430 and 440 include various applications related to user work, and are divided into two subgroups. The first group 430 is a mobile device management solution, and includes applications such as Portal 431, Teams 432, Meeting 433, and Drive 434. The Portal 431 provides information necessary for a user to one place through email, schedule management, and activity integration management, and the Teams 432 supports communication and file sharing between team members. The Meeting 433 manages a meeting schedule, and the Drive 434 provides a file storage and sharing function so that a user may efficiently access necessary information.

The second group 440 is composed of a work system and provides various work-related information required by the user. The detailed components of this group include a personnel information system 441, an education information system 442, a knowledge management system 443, and a standard process 444. The personnel information system 441 provides personnel information of users and employees, and the education information system 442 manages educational materials and learning content. The knowledge management system 443 stores and shares knowledge inside the company to help access it when necessary, and the standard process 444 provides a standard work procedure defined by the company to support the user to perform their work consistently.

In conclusion, the system illustrated in FIG. 4 represents the overall system structure in which the personalized work recommendation AI platform 301 generates user-customized work information based on the personal information 420 input by the user 110 and provides advanced information through linkage with the LLM 410. In addition, under integration the personalized work recommendation AI platform 301 with the APPS 430 and 440, the personalized work recommendation AI platform 301 may allow all work-related information required by the user to be accessed in one place, thereby reducing work hours and improving productivity.

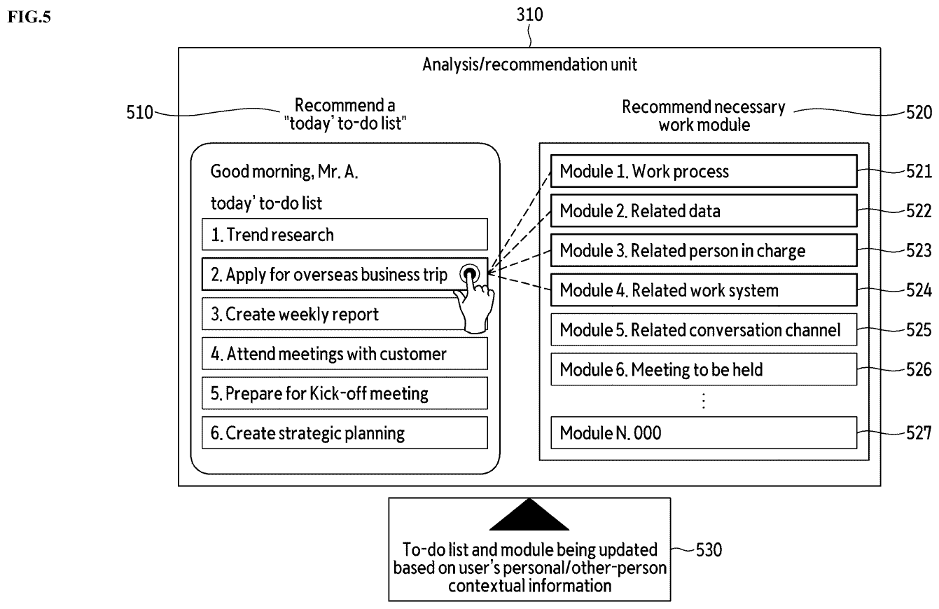

FIG. 5 is a diagram illustrating an analysis/recommendation unit in a personalized work recommendation AI platform.

FIG. 5 illustrates a screen on which the analysis/recommendation unit 310 in a personalized work recommendation AI platform 301 may recommend a “today' to-do list” 510 and a necessary work module 520 based on personal and other-person contextual information of a user 110. This system may be designed to increase work efficiency by providing a list of works that a user should perform on the same day and modules necessary for the listed works.

First, “today's to-do list 510” may be basically generated based on the user's personal contextual information. Personal contextual information is information such as the user's work experience, role, currently in progress project, schedule, etc., and may be based on elements required by the user in the work. For example, when a schedule requires a user to focus on a specific project, a related to-do list may be preferentially recommended. In addition, the “today's to-do list 510” may be based on contextual information of other person, thereby reducing redundant work and increasing collaboration efficiency. For example, when the analysis/recommendation unit 310 recommends a work to be called ‘trend research’ based on personal contextual information, but the work is a part of a team project and another member of the same team has already completed the work, ‘trend research’ may be excluded from the list based on contextual information of other person. As such, the to-do list 510 may be updated in real time according to personal and contextual information of outer person and adjusted to suit the user's current work situation.

In this example, the to-do list is recommended, and at least one or more work may be included in each list. For example, work such as ‘applying for an overseas work trip’, ‘preparing a weekly report’, and ‘meeting with a customer company’ may be included in the list, and the user may select the corresponding work and access the required module.

In the “required module recommendation 520” region, modules necessary for performing each work may be displayed. For example, in the case of the ‘overseas work trip application’ work, the work process 521, the related data 522, the related person in charge 523, and the related work system 524 may be recommended as modules necessary for performing the work. The analysis/recommendation unit 310 may not recommend a module that is not required for the ‘overseas work trip application’ work, for example, a module such as an related conversation channel 525 or a meeting to be held 526. As such, recommended modules may be different from each other based on different works, and necessary modules may be adjusted according to work characteristics.

For example, in the case of the ‘A customer meeting’ work, an related conversation channel 525 as a module 5 and a meeting to be performed 526 as a module 6 may be recommended. However, when a special work process is not required, the work process 521 as a module 1 may not be recommended. In this way, an appropriate module is recommended for each work, and unnecessary modules are excluded so that the user may efficiently perform the work.

In one example, the to-do list and the module may be updated in real time based on the “user' personal/other-person contextual information” 530. For example, when a user adds a new work or a work situation of another team member is changed, the personalized work recommendation AI platform 301 may apply this adding or change to keep the work list 510 and the necessary module 520 up to date. Accordingly, the user may always plan a work based on the latest information and reduce unnecessary work to increase productivity.

Additionally, the LLM 410 may be used in the process of generating detailed information on each work module of the analysis/recommendation unit 310.

Accordingly, FIG. 5 visually shows an example of a process in which the personalized work recommendation AI platform may provide a user with an optimized work environment by combining contextual information of the user and others with each other and suggesting a list of things to do in real time and necessary modules based on the combining result.

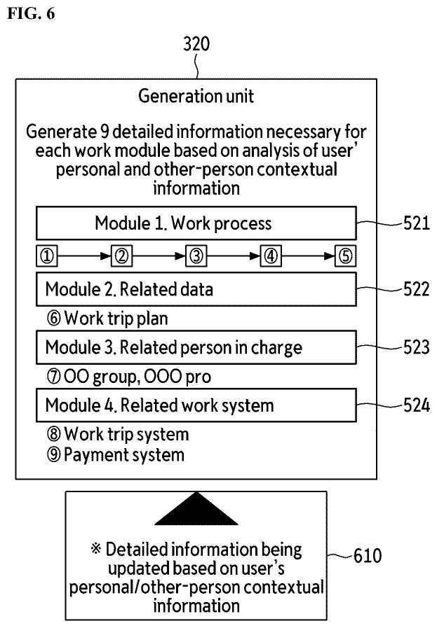

FIG. 6 illustrates the generation unit 320 of the personalized work recommendation AI platform 301 according to the example of FIG. 5.

The generation unit 320 may generate detailed information necessary for each work module based on the analysis of user' personal and other-person contextual information, thereby supporting the user to efficiently perform work. The generation unit may be designed to increase the accuracy and efficiency of the work by generating detailed information necessary for performing the work in a user-customized manner.

First, the generation unit 320 may generate detailed information on each work module. For example, 'Module 1: The ‘work process 521’ may include procedures and step-by-step guidance necessary for performing the work. In this example, there are five steps to guide the work process, and the user may perform the work while following the specific procedures of each step. As a result, the user can clearly understand the flow of work and perform all necessary step-by-step procedures.

‘Module 2: The related data 522’ may generate related data necessary for the selected work. For example, a document such as a ‘work trip plan’ may be included therein and the user may establish a work trip plan by referring to the document. The generation unit selects and provides only the data essential for performing the work, thereby reducing the process of the user searching for unnecessary data or checking duplicate data.

‘Module 3: The related person in charge 523’ may generate information of a person in charge related to the corresponding work. For example, it includes 00 group or 00% contact information to help the user to contact the person in charge immediately when necessary. This function may be particularly useful in work that require collaboration, and may facilitate communication by providing fast and accurate information to users.

‘Module 4. The related work system 524’ may guide the systems that the user needs to access to perform the work. For example, a ‘work trip system’ and a ‘payment system’ may be included, and the user may proceed with the work trip application and payment process through these systems. The generation unit may reduce the time required for the user to search for the system and support the user to quickly handle the work by essentially guiding the related system in a user-customized manner.

In one example, the generation unit 320 may update the detailed information generated based on the user' personal and other-person contextual information in real time 610. For example, when the work content of the user or the progress of other team members is changed, the generation unit may apply this change to generate information in which the necessary information or step has been changed. Accordingly, the user may always perform a work based on the latest work information, and unnecessary redundant work or information overload may be reduced.

Additionally, the LLM 410 may be used in the process of generating detailed information on each work module of the generation unit 320.

Accordingly, FIG. 6 may visually show a process in which the generation unit of the personalized work recommendation AI platform generates and updates detailed information tailored to each work module in real time, thereby generating optimized content to be provided to the user.

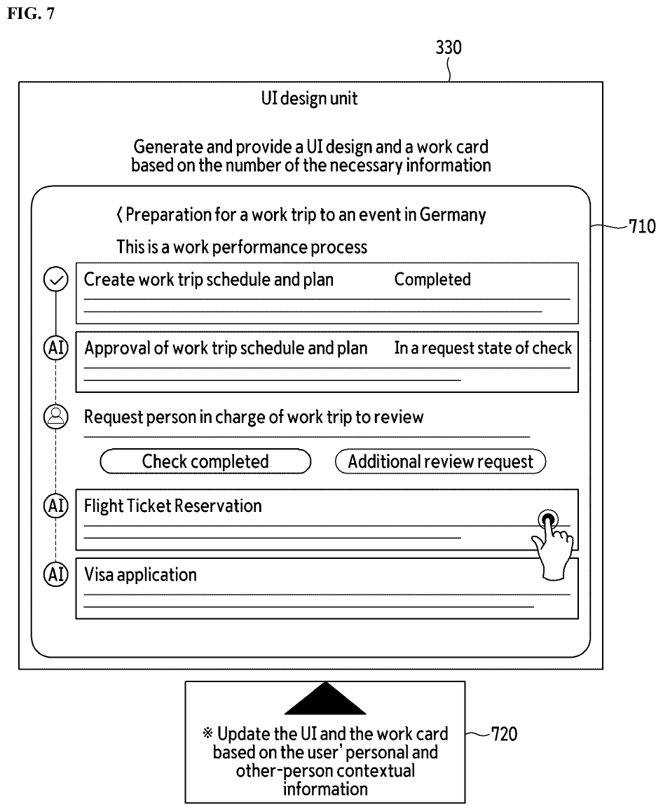

FIG. 7 illustrates the UI design unit 330 of the personalized work recommendation AI platform 301 according to the examples of FIGS. 5 and 6.

FIG. 7 illustrates a scheme in which the AI design unit 330 in the personalized work recommendation UI platform 301 provides the UI design and the work card based on the user's necessary information and contextual information. The UI design unit 330 may perform a function of helping the user to efficiently perform a work through the user-customized UI and the work card 710, and may provide an interface and information optimized for the user in real time.

First, the UI design unit 330 may generate a UI design and a work card suitable for the user based on the analysis of the necessary information. For example, the work card related to ‘preparation for a work trip to an event in Germany’ may be configured in a manner that the work card intuitively provides necessary information to a user. In this example, the work card including detailed items such as ‘work trip preparation checklist’, ‘work trip schedule and plan’, and ‘local work material preparation’ is displayed, and the user may access detailed information by clicking each item or proceed with the work while checking each step. Accordingly, the user may easily grasp the complex work procedure and prepare the work systematically.

Each item in the work card 710 may be configured according to the user's context. For example, in the ‘work trip preparation checklist’ item, a list of items or documents to be prepared by the user in advance may be provided, and in the ‘local work material preparation’ item, materials or contact information to be referred to locally may be included.

This UI design helps to reduce work preparation time by providing information tailored to user needs.

In addition, the UI design unit 330 may update the UI and the work card in real time based on the user′ personal and other-person contextual information 720. For example, when the user's schedule is changed or other team members update information on the schedule, the UI design unit may apply this change or update to generate a UI and a work card including the latest information. In this way, the UI design unit dynamically adjusts the UI and the work card according to the user's current situation and requirements, so that the user may always perform the work based on the latest information.

In one example, the UI design unit 330 may perform UI design based on LLM and may provide a work card created through LLM.

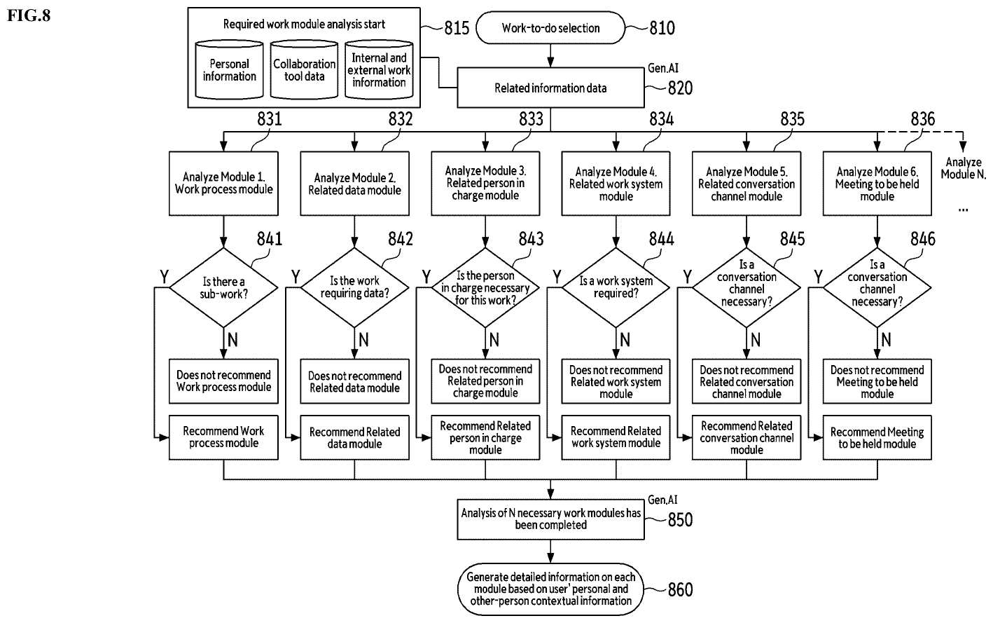

FIG. 8 is a flowchart illustrating an analysis or recommendation process in relation to an analysis/recommendation unit.

FIG. 8 may be a flowchart showing a step-by-step process in which the analysis/recommendation unit 310 of the personalized work recommendation AI platform 301 analyzes and recommends a user-customized work module. The flowchart starts from a step 810 in which the user selects a ‘work-to-do’, and includes a step of an analysis and recommendation process of a necessary work module, and a step of generating detailed information on each module based on personal and other-person contextual information of the user.

First, a ‘work-to-do selection 810’ for selecting a work to be performed may be made. For a specific work, the personalized work recommendation AI platform may start the process of analyzing a module suitable for the work. At this stage, the platform selects essential modules according to the characteristics of the work, thereby preparing to support the user to perform their work efficiently.

Next, the required work module analysis 820 may be started, and related information data 815 in which various modules required for work performance are referenced may be utilized in the analysis process. The related information data 815 may include connected tool data, work system data, internal and external work information, and the like, so that the user may access various information necessary for work. The tool data may include mail, messenger, drive, etc. In addition, the system data may include a schedule, a work-to-do, minutes, or reports. In addition, information about internal and external work in and to a company may include methodologies, bp cases, person in charge, and related data. In one example, step 820 may be a step performed through a generative AI.

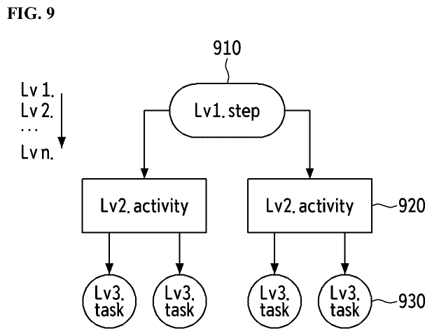

In the work module analysis step, each work module may be analyzed as an individual element that supports work performance. For example, the system may analyze the module 1. procedures and processes necessary for performing the work in 831, and in this case, it is determined whether the procedure and the process is necessary based on an answer to a question 841 of ‘Is there a sub-work?’. When there is no sub-work, the recommendation of the process may be omitted. In one example, a description of the sub-work will be described in detail in FIG. 9.

The system may analyze the module 2. related data necessary for the work in 832, and a question 842 asking ‘Is the work requiring data?’ is used to determine whether the data is necessary. For example, when a work trip plan or a project document is required, a related data module may be recommended. The system may analyze the module 3. information about a person in charge related to the work may be analyzed in 833 and it is determined whether the person in charge is necessary based on an answer to a question 843 asking ‘Is the person in charge necessary for this work?’. If necessary, a person in charge may be recommended to support the user to facilitate collaboration necessary for performing his/her duties. The system may analyze the module 4. system required for work in 834, and for example, when a work trip system or a payment system is required, whether to use a work system may be determined through a question 844 of ‘Is a work system required?’. The system may analyze the module 5. The conversation channel necessary for work in 835 and determines whether the channel is necessary based on an answer to a question 845 of ‘Is a conversation channel necessary?’. The system may analyze the module 6. the conversation channel necessary for work in 836, and it may be determined whether the channel is necessary based on an answer to a question 846 of ‘Is a conversation channel necessary?’. In addition, meeting modules and other additional modules may be analyzed as needed. In this case, the number of analyzed modules may be N.

After the analysis of each module is completed, the necessity of each work module is determined in the necessary work module analysis step 850. Through this process, a module suitable for a work selected by a user is configured, and a recommendation for a module that is not necessary is omitted, so that only necessary information may be efficiently provided to the user. In one example, step 850 may be a process performed through a generative AI.

In one example, step 860 of generating detailed information on each module may be performed based on contextual information of an individual and another person. This step may be performed in not the analysis/recommendation unit but the generation unit. In step 860, the personalized module may be kept up to date through real-time updates, so that the user may always perform the work based on accurate and necessary information. FIG. 8 may visually show a process in which the personalized work recommendation AI platform analyzes a module optimized according to a user's work selection and provides user-customized detailed information through such a series of processes.

FIG. 9 is a diagram for illustrating the sub-work of a hierarchical structure in relation to a work performance procedure.

FIG. 9 shows that the work are divided into higher to lower levels, and the levels are interconnected to each other to form an overall work process.

First, Lv1. step 910 represents the highest level of the work performance procedure, and at this step 910, a large framework of the entirety of a work may be set and a main goal or direction may be defined. The step 910 may serve to adjust a lower-level work to be performed later and manage a process for performing the entirety of a work. The step 910 as a higher level manages the overall flow of work, and may require a work process module for the lower level work as needed.

Lv2. activity 920 is a sub-work under the Lv1. step 910. More specific and detailed work levels may be included therein. The activity 920 includes a series of activities for achieving a specific goal, and may be viewed as a level of performing detailed work necessary to achieve the goal or direction set in the Lv1. For example, when the Lv1. step 910 in the project management work is the overall project planning, the Lv2. activity may be the necessary preparation and execution activity for each major step of the project. The Lv2. activity 920 operates independently but is linked to the goals of the higher level, and a work process module may be required for smooth progress of work at this level.

Lv3. task 930 is a sub-work under Lv1. step 910 and Lv2. the activity 920, and represents the most specific and detailed work element. The Lv3. task 930 is the lowest work that may be independently processed without an execution procedure, and may be focused on completing a specific work or a single work. For example, in the case of a report preparation work, the Lv3. task 930 may be composed of specific work such as writing a form of an actual report, inputting data, and finally reviewing. In this level, it may be possible to directly perform the assigned work without a procedure set in a higher level or a complex work process.

As described above, FIG. 9 visualizes a work performance structure in which the work has the hierarchical structure having the higher level to the lower level. The levels are linked to each other to achieve the overall work goal, and the levels Lv1 and Lv2 may require a work process module to manage and coordinate the sub-works with each other. On the other hand, the Lv3 task may perform an independent work, and thus a process module may not be required at this level.

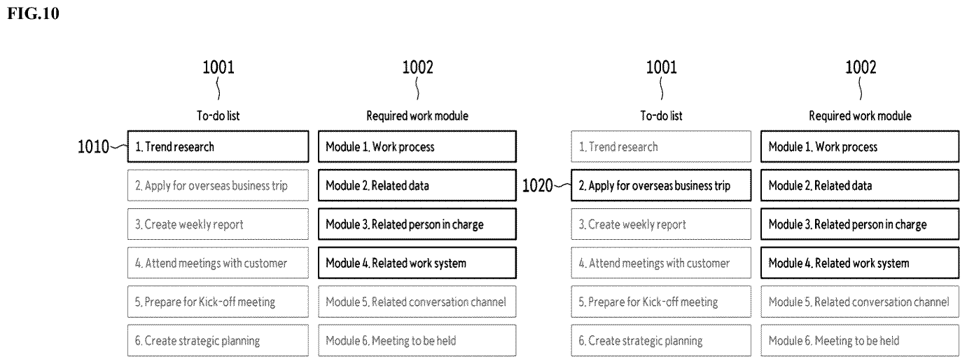

FIG. 10 is a diagram illustrating a use case of an analysis/recommendation unit according to an embodiment of the present disclosure.

FIG. 10 illustrates an example of using the analysis/recommendation unit 310 according to an embodiment of the present disclosure, and illustrates a process of recommending a ‘work module 1002’ required for a specific work selected by a user from a ‘to-do list 1001’. FIG. 10 shows a structure in which a user may efficiently check and select a necessary module according to each work.

The to-do list 1001 is a list including various works to be performed by the user, and the user may select a necessary work from this list to perform the selected work. Each item represents a specific work, whereby the user may select an appropriate item suitable for his or her work situation.

The required work module 1002 is composed of modules necessary to perform a specific work selected by the user. The required work module 1002 includes essential data, support system, and person-in-charge information on each work to allow the user to easily check the information necessary for performing the work.

1010 means that the ‘trend research’ work is selected from the ‘to-do list 1001’. In this case, the module required for this work is composed of the module 1 (work process), the module 2 (related data), the module 3 (related person in charge), and the module 4 (related work system). These modules allow users to receive all the data and support they need to efficiently perform ‘trend research’ work.

1020 shows an example of selecting the ‘overseas work trip application’ work from the ‘to-do list 1001’. The required work module for this work is also composed of the module 1 (work process), the module 2 (related data), the module 3 (related person in charge), and the module 4 (related work system), through which the user can check information and data necessary to perform the ‘overseas work trip application’ work.

FIG. 10 is only an example of the use case of the analysis/recommendation unit, and the present disclosure is not limited to this example. Various works may be added to the to-do list 1001, and the configuration of the necessary work module 1002 suitable for each work may be changed. FIG. 10 visually shows a process of recommending a necessary work module according to a work selected by a user, and thus the user may efficiently check and access all elements necessary for performing the work.

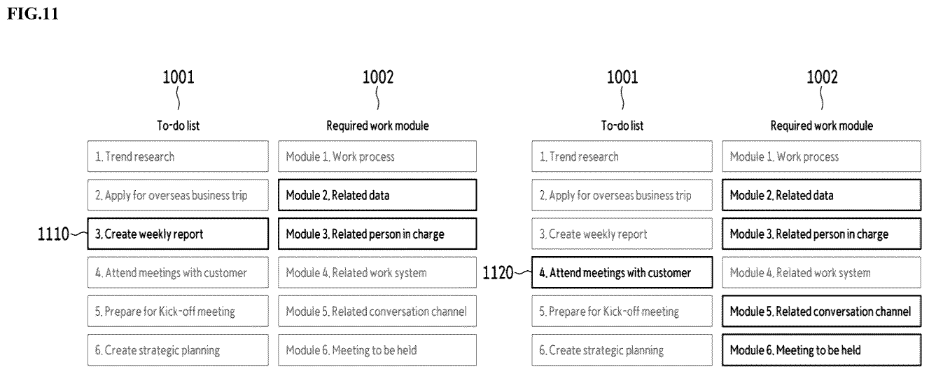

FIG. 11 is a diagram illustrating another use case of an analysis/recommendation unit according to an embodiment of the present disclosure. FIG. 11 shows that when the user selects a specific work from the ‘to-do list 1001’, how the ‘necessary work module 1002’ required for the selected work may be recommended.

For example, when a work of creating a weekly report 1110 is selected, the required work modules may be composed of the module 1 (work process), the module 2 (related data), and the module 3 (related person in charge). These modules include the data and support information necessary for the user to prepare the weekly report, and may provide all the information necessary for the weekly report preparation process.

In another example, it may be identified that the customer meeting attendance 1120 work is selected. The required work module for this work may be comprised of the module 2 (related data), the module 3 (related contacts), the module 5 (related conversation channels), and the module 6 (meeting to be held). Since the customer meeting work requires communication with other team members, the conversation channel module 5 and the meeting module 6 are included therein, so that the user can complete all preparations to participate in the meeting as well as the necessary data and contact information.

FIG. 11 is merely an example of the use case of the analysis/recommendation unit, and the present disclosure is not limited to this example. Various works may be added to the to-do list 1001, and the configuration of the necessary work module 1002 suitable for each work may be changed. FIG. 10 visually shows a process of recommending a necessary work module according to a work selected by a user, and thus the user may efficiently check and access all elements necessary for performing the work.

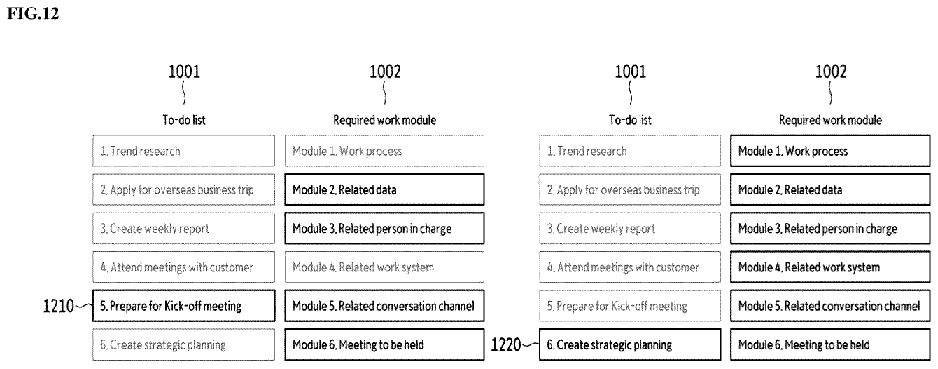

FIG. 12 is a diagram illustrating still another use case of the analysis/recommendation unit according to an embodiment of the present disclosure.

FIG. 12 shows that when the user selects a specific work from the ‘to-do list 1001’, how the ‘necessary work module 1002’ required for the selected work may be recommended.

For example, when the work of preparing for the kick-off meeting 1210 is selected, the required work module recommended accordingly may be comprised of the module 2 (related data), the module 3 (related person in charge), the module 5 (related conversation channel), and the module 6 (meeting to be held). These modules provide users with the resources and supporting information needed to prepare for the kick-off meetings and help them efficiently prepare all the elements needed for meetings.

In another example, when the work of creating a strategic plan 1220 is selected, the required work module therefor may include the module 1 (work process), the module 2 (related data), the module 3 (related person in charge), the module 5 (related conversation channel), and the module 6 (meeting to be held). Since the preparation of the strategic plan requires various data and collaboration, the modules may support the smooth progress of work, including necessary data and information of the person in charge, as well as dialog channels and meeting support modules.

FIG. 12 is merely an example of various uses of the analysis/recommendation unit, and the present disclosure is not limited to this example. Various works may be added to the to-do list 1001, and the configuration of the necessary work module 1002 suitable for each work may also be changed. FIG. 12 visually shows a process of recommending a necessary module according to a work selected by a user, and thus the user may efficiently check and access all elements necessary for performing the work.

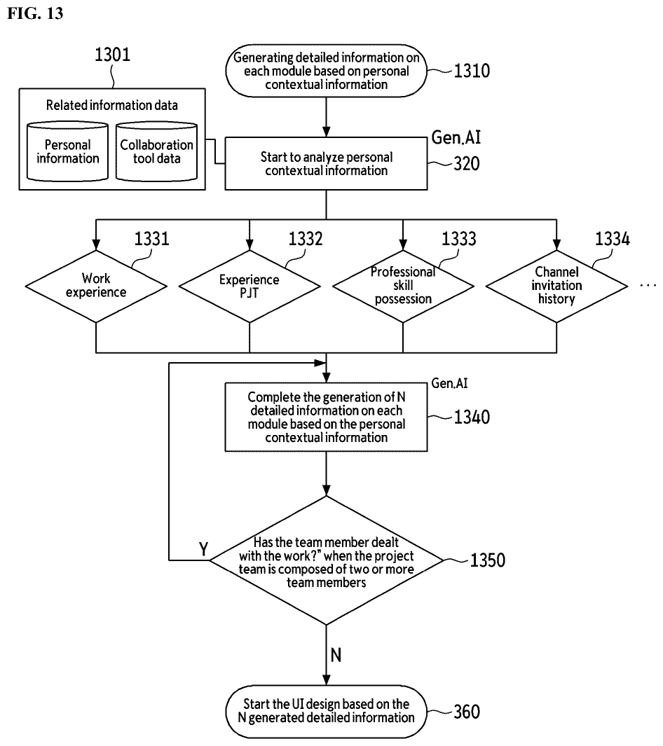

FIG. 13 is a flowchart illustrating a process of generating detailed information in relation to the generation unit.

This process describes a series of procedures for generating necessary module-specific detailed information based on the user's personal contextual information and other-person contextual information and finally starting the UI design.

First, in step 1310 of generating detailed information on each module based on personal contextual information, an operation of generating detailed information on each module based on the user's personal contextual information is started. In this step, personalized information is collected and analyzed to lay the foundation for the subsequent generation of detailed information on each module. In one example, in some cases, detailed information on each module may be generated based on not only the personal contextual information but also other-person contextual information.

The related information data 1301 may include various information that may be referred to in this process. This may include tool data (e.g., mail, messenger, drive, meeting) related with the personal information (e.g., proficiency, career, performance, experience project, etc.) related to the user, and such information may be used as important data to generate detailed information suitable for the user's work characteristics.

Next, in step 1320 of analyzing the personal contextual information, the personalized AI generation system starts to analyze the user's contextual information. This information refer to basic data for generating detailed information suitable for the user, and includes various factors such as an individual's career, work performance, and experience project. In step 1320, in some cases, not only the personal contextual information but also the other-person contextual information may be analyzed together. In this case, step 1320 may be a step performed based on the generative AI.

In a work experience 1331 step, it is determined whether the user has sufficient experience accumulated in a specific work. Upon determination that there is sufficient experience thereon, the process proceeds to the next step. Through this process, detailed information suitable for the user's career level may be generated. An experience PJT 1332 step is a step of determining whether the user has a specific project experience, and upon determination that there is an experience of performing a similar project in the past, detailed information may be provided based on the experience. In a professional skill possession step 1333, it is checked whether the user has a specific professional skill. Upon determination that the user possesses the specific professional skill, detailed information corresponding thereto may be generated to provide data suitable for work. In a channel invitation history step 1334, it is checked whether a user has a history of being invited to a specific channel. Upon determination that the user is participating in the specific channel, necessary information therefor may be additionally provided.

In step 1340 of completing the generation of N detailed information on each module based on the personal contextual information, the N detailed information on each module required based on the contextual information of the user is generated. As a result, all preparations for UI design are completed, and in a subsequent step, the UI design may be performed based on the generated information. This process may be performed by a generative AI, and automated analysis is performed to generate the user-customized information. In some cases, the detailed information on each module may be generated based on not only the personal contextual information but also the other-person contextual information. In this case, the step 1340 may be a step performed based on the generative AI.

Thereafter, in the case of PJT (2 or more), in step 1350 of “Has the team member dealt with the work?”, when the project team is composed of two or more team members, it is checked whether the work has already been dealt with by another team member. In response to that another team member has dealt with the work, the relevant information may be adjusted to prevent redundant work.

In step 1360 of starting the UI design based on the N generated detailed information, the user-customized UI design is started based on the finally generated detailed information. In this step, all necessary detailed information is applied to the UI, thereby providing an environment in which the user may perform the work more efficiently. In one example, the step 1360 may be a step performed by the UI design unit rather than the generation unit.

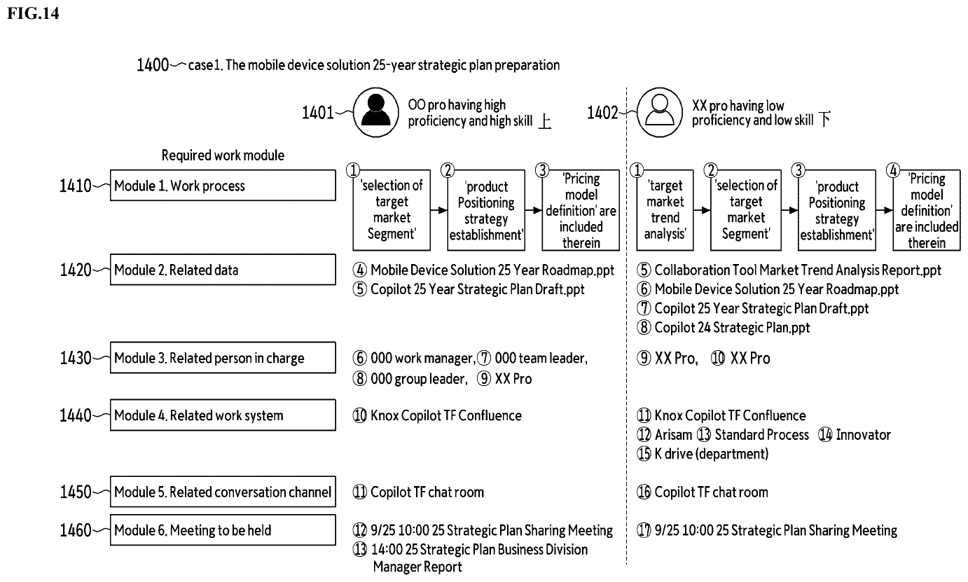

FIG. 14 is a diagram illustrating a use case of a generation unit according to an embodiment of the present disclosure.

FIG. 14 is a view illustrating a process of generating detailed information of different levels based on a work skill or expertise of a person in charge, in an example of using a generation unit according to an embodiment of the present disclosure. FIG. 14 shows how detailed information optimized for each of the highly-skilled person and the low-skilled person is generated for a specific work called “Creating a 25-year strategic plan for mobile device solutions”.

First, case1. The mobile device solution 25-year strategic plan preparation 1400 represents a specific work, and two persons in charge of this work are provided with detailed information in different ways. The OO pro 1401 has high proficiency, such that basic information is omitted and detailed information composed mainly of key contents is provided thereto. On the other hand, since the XX pro 1402 has low proficiency, more meticulously configured detailed information including basic contents is provided thereto. In this way, the generation unit generates optimized information according to the different expertise and proficiency levels of the two persons in charge of the work in different manners.

Module 1. The work process 1410 generates main procedures and operations for performing the work. In this regard, for the highly skilled OO professional 1401, only key procedures such as ‘selection of target market Segment', 'product Positioning strategy establishment', and 'Pricing model definition’ are included therein. On the other hand, for the low-skilled XX pro 1402, the detailed information including an additional initial step such as ‘target market trend analysis’ is included therein, so that a procedure throughout the work is more specifically generated.

Module 2. The related data 1420 includes data necessary for performing the work. For OO Pro 1401, only key data such as ‘Mobile Device Solution 25 Year Roadmap. ppt’ and ‘Copilot 25 Year Strategic Plan Draft. ppt’ are generated. On the other hand, for XX Pro 1402, a wider range of data is generated. For example, additional background data such as ‘Collaboration Tool Market Trend Analysis Report. ppt’ or ‘Copilot 24 Strategic Plan. ppt’ are included therein, and basic data to help understand the work are also generated.

Module 3. The related person in charge 1430 generates a list of people to collaborate with. For the OO Pro 1401, the detailed information includes key people such as ‘000 work manager’, ‘000 team leader’, and ‘000 group leader’, which are major managers. On the other hand, for the XX Pro 1402, a more comprehensive list of people to be collaborated is generated, including all related people necessary for collaboration.

Module 4. The related work system 1440 represents a system that supports work performance. In this regard, only a main system such as ‘Knox Copilot TF Confluence’ is generated for the OO Pro 1401. On the other hand, for the XX Pro 1402, various work systems such as ‘Arisam’, ‘Standard Process’, ‘Innovator’, and ‘K drive (department)’ are additionally created to help him to perform the work more systematically.

Module 5. The related conversation channel 1450 generates a chat room capable of communicating in real time. Only the ‘Copilot TF chat room’ which is a main chat room, is generated for the highly skilled OO professional 1401, whereas a conversation channel for collaboration is generated more widely for the less skilled XX professional 1402.

Module 6. The meeting 1460 to be held generates a scheduled meeting schedule. In this regard, only a main meeting schedule is generated for the OO pro 1401, and a schedule including detailed information on each meeting is generated for the XX pro 1402. For example, not only the key schedule such as the ‘ 9/25 10:00 25 Strategic Plan Sharing Meeting’, but also the detailed purpose of the meeting and the participants are described in detail.

FIG. 14 shows a scheme in which the generation unit generates information optimized according to the skill level and expertise of the person in charge, and visually presents how the amount and content of information may vary according to the skill level. Accordingly, the user can receive information generated according to his or her work ability and efficiently perform the work.

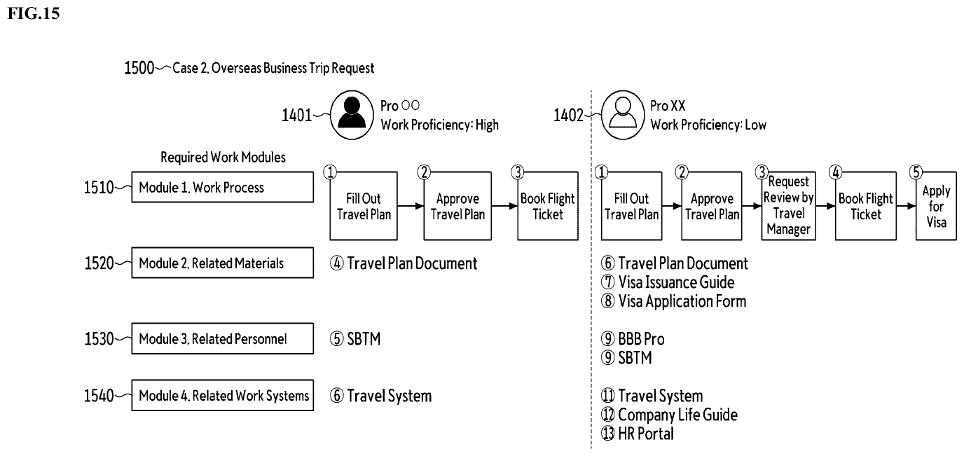

FIG. 15 is a diagram illustrating another use case of a generation unit according to an embodiment of the present disclosure.

FIG. 15 is another example of use of a generation unit according to an embodiment of the present disclosure, and is a diagram illustrating how detailed information optimized for each of a user with high work proficiency and a user with low work proficiency is generated for a work called ‘overseas work trip application’. This example visually presents how the user-customized work information providing system optimizes and generates information according to the skill level of the person in charge.

First, case2. An overseas work trip application 1500 represents a specific work trip application work, and the highly skilled OO professional 1401 and the less skilled XX professional 1402 are provided with detailed information in different ways. Since the OO pro 1401 is a senior member and has a lot of experience, the information is briefly generated based on key information. However, since the XX pro 1402 is a junior member, the information is generated in more detail including basic contents.

Module 1. In the work process 1510, an overseas work trip application procedure is generated. For OO Pro 1401, only key processes such as ‘Writing a Work Trip Plan’, ‘Approving a Work Trip Plan’, and ‘Booking a Ticket’ are generated. On the other hand, for the XX professional 1402, more detailed steps are generated including basic procedures such as ‘preparation of a work trip plan’, ‘approval of a work trip plan’, ‘request for review of a work trip person’, ‘reservation of a flight ticket’, and ‘application for a visa’. In this way, a differentiated approach in which the module omits procedures already familiar to the OO Pro, and creates and provides all necessary procedures for the XX Pro may be applied.

Module 2. In the related data 1520, essential data related to the work is generated. For the OO Pro 1401, the module generates only major data such as ‘work trip plan’, which is composed of minimum essential data for work trip preparation. On the other hand, for the XX Pro 1402, ‘work trip plan’, ‘visa issuance guide’, and ‘visa issuance application’ are additionally generated by the module. The XX Pro will be provided with more detailed data needed during the work trip application process, including the basic information needed to perform its work.

Module 3. The related person in charge 1530 represents a collaboration person in charge related to a work trip. For the OO Pro 1401, only key person such as ‘SBTM’ are created as the person in charge to collaborate. On the other hand, for the XX Pro 1402, information about the final approver related to the work trip and the person in charge of other departments to be referred to, and specific information on the person in charge such as ‘Choi Joon-young Pro’, etc. are additionally generated so that more support may be received in the collaboration process.

Module 4. The related work system 1540 generates a work system required for a work trip application. For the OO pro 1401, only an essential system such as a ‘travel system’ is generated. On the other hand, additional work systems such as a ‘work trip system’, a ‘company life guide’, and a ‘HR Portal’ are generated for the XX pro 1402. This helps the XX Pro to understand the work trip application process more clearly with referring to additional information needed for work.

FIG. 15 shows a scheme in which the generation unit generates optimized information according to the skill level of the person in charge as described above, and visually presents how the scope and content of information may be adjusted according to the skill level. Accordingly, the system may allow the highly skilled user to receive only key information and allow the less skilled user to receive the more detailed information, thereby maximizing the work efficiency of each of the users.

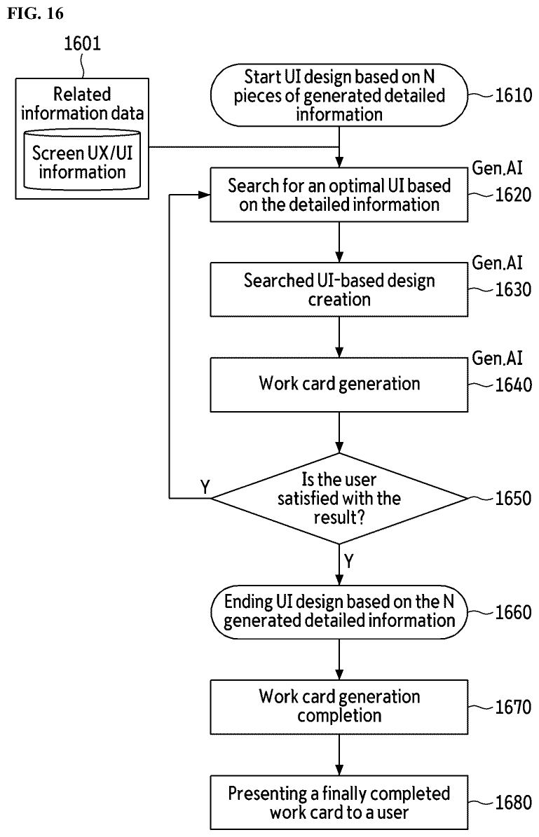

FIG. 16 is a flowchart illustrating a process of generating a work card in relation to an UI design unit.

FIG. 16 is a flowchart illustrating a process of generating a work card in relation to an UI design unit according to an embodiment of the present disclosure. A series of processes of designing an optimized UI based on the generated detailed information to generate a work card suitable for a user are illustrated.

First, in step 1610 of starting UI design based on N pieces of generated detailed information, UI design is started based on N pieces of detailed information. The related information data 1601 that may be referred to in the UI design process is composed of screen UX/UI information, and thus the user may implement an optimized UI design. The related information data may include elements essential to the user interface, such as playouts, icons, and components.

Next, in step 1620 of searching for an optimal UI based on the detailed information, the optimal UI is searched for based on the generated detailed information. This process is performed by a generative AI (Gen. AI), and may search for the most suitable UI for the user based on various UX/UI information and previous UI design experience,.

Thereafter, in the searched UI-based design creation step 1630, an actual design is created based on the information searched for as the optimal UI. In this process, a generative AI is also used to quickly create the UI design that meets user requirements and work characteristics.

Next, in a work card creation step 1640, a work card that may be used by the user is created based on the optimized UI design. The work card refers to a card-type UI element designed for easy access by the user thereto, and supports efficient work performance by visually providing key information on each work. In this step, the generative AI may also be utilized.

In “Is the user satisfied with the result?” step 1650, it is checked whether the created work card satisfies the user's request. In response to that the user is not satisfied with the result, the UI design unit may return to the optimized UI search step 1620 again, repeat the search and design process, and provide an optimal UI that satisfies the user's needs.

In response to that the user is satisfied with the result, step 1660 of ending the UI design based on the N generated detailed information is performed to end the UI design process. At the same time, all processes are completed in the work card creation completion step 1670. Thus, the user may receive the created work card in a presenting step 1680 of a finally completed work card to the user.

FIG. 16 visually presents an entirety of a process in which the UI design unit generates the user-customized work card as described above, and shows a scheme of providing an optimal UI and an optimal work card based on user feedback.

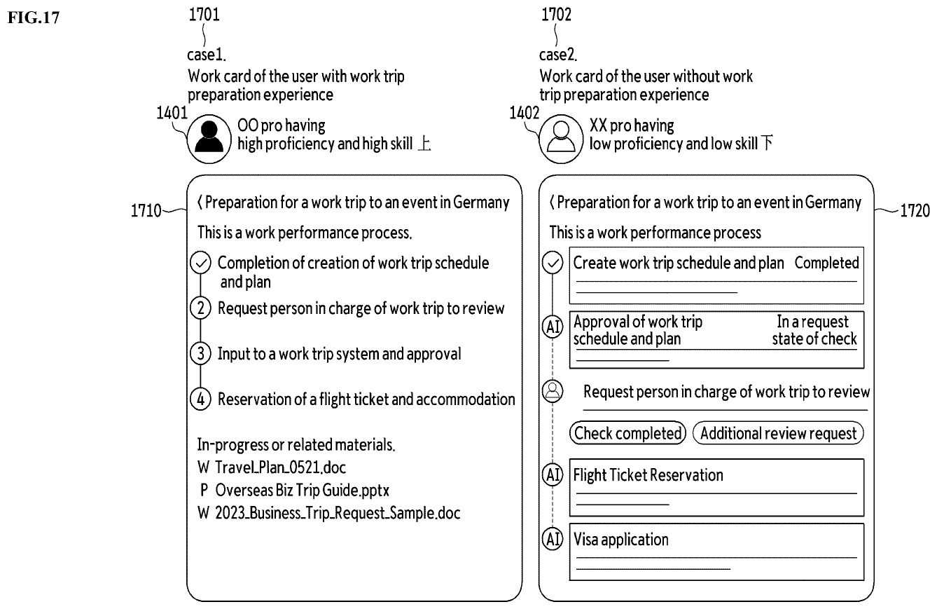

FIG. 17 is a view illustrating a process of generating a work card required for performing a work at different levels according to user skill levels, in an example of using an UI design unit according to an embodiment of the present disclosure.

FIG. 17 visually presents how a work card optimized for each of the user with work trip preparation experience and the user without work trip preparation experience is provided regarding the same work of ‘preparing for a work trip to a German event’.

First, case1. The work card 1701 of the user with work trip preparation experience is a card designed for the OO Pro 1401 as a user with high work skill. This work card 1710 simply displays only key information and step so that the user may efficiently perform the work. For example, major work procedures such as ‘preparation of a work trip plan’, ‘request for review of a person in charge of a work trip management’, ‘input to a work trip system and approval’, and ‘reservation of a flight ticket and accommodation’ are listed in a simple text form, so that a highly skilled user may quickly identify and execute each step. In addition, the related materials are provided in the form of a list at the bottom so that the user can quickly access the necessary materials.

On the other hand, case2. The work card 1702 of a user who has no work trip preparation experience is a detailed card for the XX Pro 1402 as a user with a low-level work skill. This work card 1720 provides more detailed instructions to the user, including detailed descriptions and guidance messages about each work step. For example, in the ‘work trip plan preparation’ step, key information to be included in the plan document and writing tips thereof are provided, and in the ‘work trip plan approval’ step, necessary measures are guided along with detailed descriptions of the approval process. In addition, the “request for review of the person in charge of work trip management” step includes information and contact information of the person in charge of the work trip management, helping users to easily contact him/her. In addition, even in the ‘ticket reservation’ and ‘visa application’ steps, precautions and procedures at each step are provided in detail, so that inexperienced users may secure all necessary information and proceed with the process smoothly.

In addition, upon determination that the proficiency of the XX pro 1402 is improved based on personal contextual information or other-person contextual information, the UI design unit may update the work card based on this determination. For example, when the XX professional has improved proficiency through several repetitive works in the process of preparing for the work trip, or has indirectly gained experience through the work situation of another team member, the work card may be automatically updated in a simplified format in which basic contents are omitted. As a result, the XX Pro receives only information tailored to his/her skill level, so that the work may be performed more efficiently and quickly.

FIG. 17 shows a scheme in which the UI design unit provides optimized information according to the user experience level as described above, and visually presents that the amount of information and detailed level of the work card may vary according to the skill level. As a result, the user is provided with the user-customized guidance tailored to his or her skill level and work experience, so that he or she may efficiently perform his or her work.

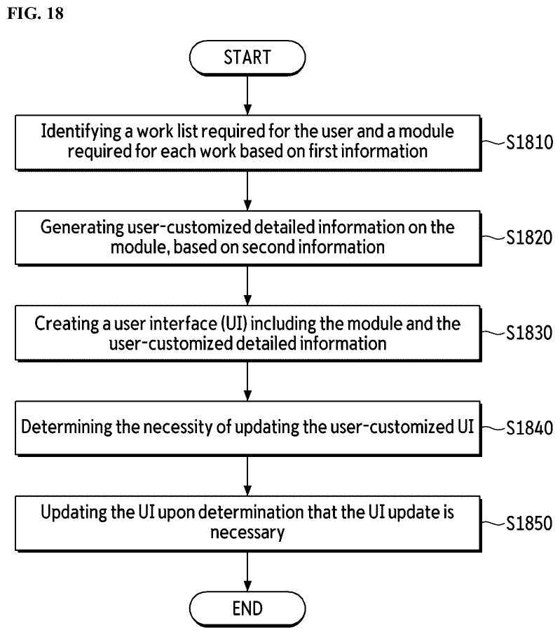

FIG. 18 is a flowchart illustrating an entirety of a process of providing personalized work information according to an embodiment of the present disclosure.

Step S1810 is an important initial step of identifying a work list required for the user and a module required for each work based on first information. The first information is mainly information including the work system data about the first user, and may be used to analyze the details and requirements of the work being performed by the user. The work system data may include various information related to a work, such as a work content assigned to a user, a work progress status, a work deadline, and a priority. This information is stored in the work server, and the user-customized work recommendation AI platform can access this information and analyze the same.

In relation to the step S1810, the work list generated based on the work system data may be a list listing various works to be currently processed by the user. This work list may include at least one work, and may include various items according to the type, importance, and progress of the work. For example, the work list may include specific works such as “preparing a weekly report,” “planning a project,” “preparing for a team meeting,” and “attending a customer meeting.” Such a work list may be dynamically updated according to the user's current work situation and priorities, and helps the user to easily grasp the work immediately required.

In relation to the step S1810, at least one module may be required to process the individual work. The module is a concept that refers to tools, data, a support system, etc. necessary for performing a specific work, and is user-customized according to the characteristics of the work and the needs of the user. For example, a ‘work process module’ and a ‘related data module’ may be required to perform the work of “preparing a weekly report”. In this case, the work process module guides the weekly report preparation procedure, and the related data module provides past report data or reference data. In another example, the work of “attending a customer meeting” may require a ‘conversation channel module’ and a ‘meeting to be held module’, thereby facilitating communication with a related person in charge before the meeting and preparing meeting data that may be used for the meeting.

In the step S1810, the work list required by the user and the module suitable for each work may be efficiently identified. In the subsequent step, the user-customized work information and UI configuration may provide a foundation for the user to smoothly perform the work.

Step S1820 is a step of generating user-customized detailed information on the module identified in the step S1810, based on second information. The second information used in this step is mainly information including the experience of the user, and may include the user's skill level, work processing experience, past work history, professional knowledge level, and the like. For example, information such as how often the user has previously performed the work and how much proficiency the user has with respect to a specific skill or tool related to the work may be used as the second information. This experience data may be analyzed by the user-customized work recommendation AI platform and subsequently, the analysis result may be used as the basic data to provide the optimized detailed information to the user.

The user-customized detailed information generated in the step S1820 may provide specific guidelines and data about each module identified in the step S1810. For example, in the case of a “work process module”, only a brief procedure may be provided, or a detailed description may be added step by step, depending on the user's skill level. For the highly skilled user, only key procedures may be briefly presented, whereas for the less skilled user, all necessary details from the start to completion of the work may be guided in detail.

In relation to the step S1820, the user-customized detailed information of the related data module may recommend or provide data that the user may need for the work. For example, in relation to the reporting work, the user's past report data or the company's standard template may be presented as user-customized data, and the data or references frequently used by the user in the past may be preferentially displayed to increase access to the data necessary for performing the work.

In relation to the step S1820, the conversation channel module may include a chat room related to the user's previous collaboration experience, a key person in charge, a message record for reference, and the like. For example, a contact number of a team member who has collaborated on a similar project in the past or a link to a real-time chat room related to the project may be provided as user-customized detailed information to support immediate communication.

The step S1820 provides the basis for the user to perform the work more efficiently by generating necessary information according to the user's individual experience and proficiency.

Step S1830 is a step of generating a user interface (UI) including the module and the user-customized detailed information generated in the step S1820. The UI created in this step is provided through a screen of a user terminal (e.g., a smartphone, a tablet, or a computer), and helps the user to intuitively identify and perform the work. The UI may be mainly provided in a form of a work card, so that the user may check all information and procedures necessary for the individual work at a glance.

In this case, the created UI may be constructed in the user-customized manner based on the user's personal contextual information and the other-person contextual information. The user's personal contextual information includes the user's proficiency, work experience, and characteristics of the currently ongoing work, and thus the UI may be provided so as to include the information optimized for the user. For example, when the user is an experienced person in charge which has experienced the frequent work trips, the UI may be created that is free of unnecessary detailed information and provides only essential information.

On the other hand, the UI may be designed more efficiently based on the other-person contextual information. The other-person contextual information may include a work progress situation already performed by other members of the same team or a completed procedure performed by other members of the same team. For example, when a user's work is related with a team project and another team member has already completed a specific work, the UI may indicate that the specific work does not need to be performed in a redundant manner and may guide the user to omit unnecessary procedures. As a result, the user may reduce redundant work and perform the work more efficiently.

In addition, the UI created in the step S1830 may include a button interface for checking whether the user is satisfied with the UI. This button interface allows the user to leave feedback on the provided UI and user-customized information, thereby allowing the system to continuously improve the user experience. In this regard, the interface may be configured such that the user may select “satisfied” or “dissatisfied” or input specific feedback. Thus, the generation unit may secure important data that may be used to improve the UI and an information providing scheme based on this feedback.

In relation to the step S1830, the UI may be constructed in the user-customized manner according to the user's skill level and experience level. In the case of highly skilled users, basic guidance or description may be omitted, and only key information necessary for performing the work may be concisely presented. For example, when a highly skilled user prepares for a work trip, the UI may be created that provides only a simple confirmation checklist such as “ready to leave” and a key schedule.

On the other hand, a UI including detailed guidance step by step may be provided to a user with low proficiency or unfamiliar with the work. In this case, the UI helps the user to perform the work without confusion by listing information such as detailed descriptions of the work procedure, a list of necessary materials, and reference documents step by step. For example, a user who prepares for a work trip at first receives a UI in which detailed steps of preparing for a work trip, a document preparation method, and necessary information of a person in charge are provided in order, so that all steps necessary for performing the work may be performed in an non-omitted manner.

In relation to the step S1830, the created UI may provide the user with the latest information through a real-time update function. When new information is added or procedures change as the work progresses, the UI may be automatically updated to support the user to perform the work based on the latest information. For example, when a new document is added the work card or a new procedure is added to the work card, the UI may apply the new document or procedure in real time to guide the user to take necessary action immediately.

Step S1840 is a step of determining the necessity of updating the user-customized UI, and may be mainly performed based on the user's feedback on the UI created in the step S1830. At this step, the system checks whether the UI is sufficiently compliant with the user's needs, or whether additional information or modification is required.

First, the system receives and analyzes the feedback provided from the user to the UI created in the step S1830. For example, when the user is not satisfied with the contents of the UI or indicates that additional description is needed, the system may determine that the UI update is needed in consideration of the feedback. The feedback is collected through the satisfaction button included in the UI, and the user may select “satisfaction” or “dissatisfaction” or input specific improvements.

In addition, changes in the user's personal contextual information and the other-person contextual information may also be important factors for determining the necessity of UI update. For example, when the user's work proficiency has been improved or the relevant team member has completed a new work step, the system may apply the improvement or the completion to review the information configuration of the UI. For example, upon determination that the user's work skill level has been improved, the system may determine that it is necessary to simplify the UI in a form of providing only the main information while omitting the basic description therefrom.

When it is determined that an update is not necessary at this step, the process may proceed to the next step without further action, and the current UI is maintained as it is. Conversely, upon determination that an update is necessary, the UI is improved and is set to provide more suitable information to the user.

The step S1840 may be designed such that the system operates effectively even in situations where real-time update is important. For example, when the work environment or related information is frequently changed, the system may continuously evaluate the need of the UI update based on a detecting result of such changes in real time. Accordingly, the user may always perform the work based on the latest information, and the accuracy and efficiency of the work may be improved.

In conclusion, the step S1840 refers to a process of reviewing improvements so that the UI is configured to meet user needs as much as possible, in sensitively response to the user feedback and the contextual information change, so that the user may always perform the work in an environment optimized for him/her.

Step S1850 is a step of actually updating the UI when it is determined in the step S1840 that the UI update is necessary. In this step S1850, the UI may be newly configured or supplemented according to the user's feedback and the contextual information. In this step, the user-customized UI is changed to an optimized form based on the information collected in the step S1840 and the determination result in the step S1840

First, upon determination that the update is necessary in the step S1840, the system identifies specific items to be applied to the UI. For example, when the user additionally requests detailed information of a specific work or new content is added to the user's personal contextual information or the other-person contextual information, the system may reconstruct the element required in the UI based on the above request or the addition of the new content.

The UI update performed in this step may be performed in various ways. For example, when the user requests the additional information, a new work card or a guide message including the additional information may be displayed on the UI. When there is a feedback that a description of a specific step is unnecessary, the specific step may be omitted from the UI or abbreviated in the UI. In addition, when there is an element that the user was not satisfied with in the previous step, the system may supplement the element to provide improved functionality or clearer information in the updated UI.

The updated UI is provided in a form optimized for the user's current state, which helps the user to more intuitively and efficiently check the information required when performing the work. For example, when the user needs additional collaboration information, a list of persons in charge related to the collaboration may be newly included in the updated UI, and additional data or the related system link required for work progress may be placed in the UI such that the user may be directly accessible thereto.

In one example, the UI update may be performed in real time, so that the user may immediately utilize the latest information. This allows not only the user feedback but also changes in the user's personal contextual information or the other-person contextual information to be immediately applied to the UI. For example, when the work of another person in the team has been completed and thus the related information thereto has been changed, the UI of the user is updated in real time based on the completion and the change, and accordingly, the user may check the latest status information required for his/her work at any time.

In conclusion, the step S1850 is the final step of allowing the user-customized UI to be dynamically updated according to user needs and contextual information change, thereby continuously improving the user experience and increasing the accuracy and efficiency of work performance.

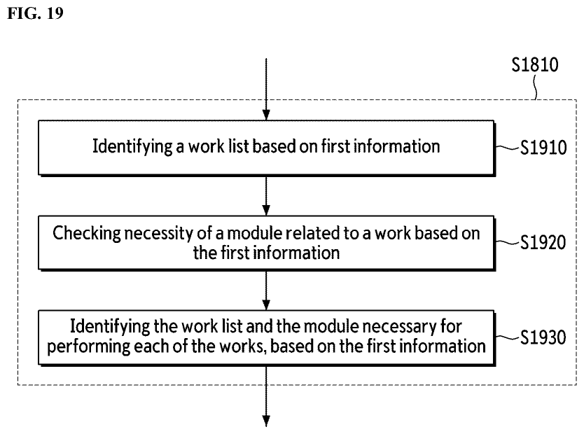

FIG. 19 is a diagram illustrating detailed steps of the step S1810 according to an embodiment of the present disclosure.

Step S1910 is a step of identifying a work list based on first information. In this step, the first information is basic information such as the user's work system data, and may be used to define a work item to be performed by the user. For example, the work list required for the user may be derived in consideration of the work characteristics of the user or the current project situation. The work list may include major work items related to a specific project, thereby laying the foundation for the user to grasp the priority of the work and perform the work systematically.

Step S1920 is a step of checking necessity of a module related to a work based on the first information. After the work list is derived, the characteristics of each work are reviewed to determine the module required for each of individual work items. In this step, the system may evaluate the functional elements and support resources required for each work to determine what module is actually needed to perform the work. For example, when a specific work is related to document creation, a ‘document management module’ may be required. In the case of a work requiring external collaboration, a ‘communication module’ may be additionally required.

Step S1930 is a step of finally identifying the work list and the module necessary for performing each of the works, based on the first information. In this step, a necessary module is finally determined based on the previously reviewed necessity evaluation result, and the resources required to perform the work are allocated accordingly. For example, when a user needs to perform a ‘weekly report preparation’ work, a module necessary for document preparation, a data search module, an approval module for internal review, etc. may be finally selected.

FIG. 19 visually presents a process in which the step S1810 is executed more specifically and systematically through these detailed steps, thereby showing that the user-customized work list and the user-customized module may be accurately configured.

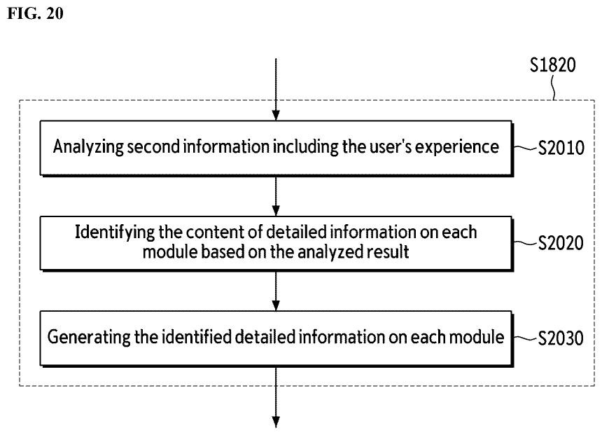

FIG. 20 is a diagram illustrating detailed steps of the step S1820 according to an embodiment of the present disclosure.

Step S2010 is a step of analyzing second information including the user's experience. In this step, the second information such as the user's work proficiency, processing experience, and whether the user has a specific skill is analyzed. For example, the user's past work performance data and the corresponding performance information may be included therein, and accordingly, the user's understanding and expertise of the work may be evaluated. This second information plays an important role in providing the module-specific user-customized information so that the user may access the same more easily.

Step S2020 is a step of identifying the content of detailed information on each module based on the analyzed result. Specific information required for each module is determined based on the user's experience and proficiency analyzed in the step S2010. For example, when the user is highly skilled in a specific work, advanced data or summarized information rather than a basic description may be provided to the user. On the other hand, the detailed information including step-by-step guidelines and supporting data for all steps necessary for performing the work may be provided to the low-skilled user.

Step S2030 is a step of generating the identified detailed information on each module. Finally, the user-customized detailed information is generated based on the information identified in the step S2020. In this regard, the generated information includes specific contents on each module, and provides all the details necessary for the user to perform the work. For example, briefly summarized data may be provided to a highly skilled user, whereas detailed information such as a step-by-step guide may be generated and provided to a less skilled user.

FIG. 20 shows that the overall process for providing the user-customized information for the user's work performance is configured to include such detailed steps and is systematically performed. Thus, the user may receive appropriate information suitable for his/her experience and level and thus may effectively perform the work.

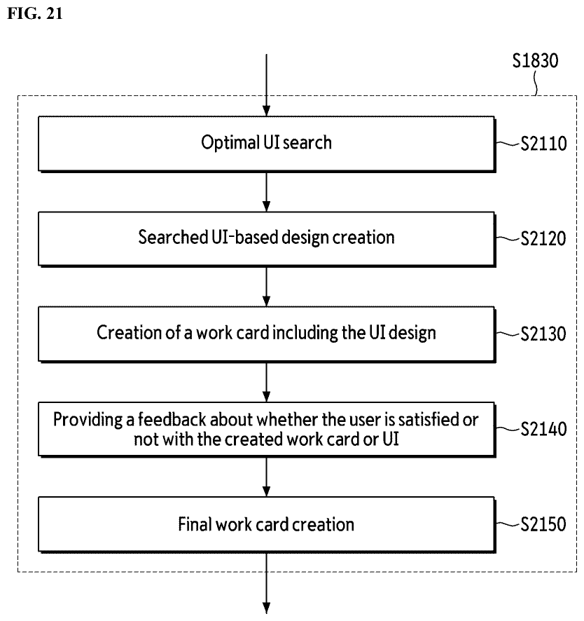

FIG. 21 is a diagram illustrating detailed steps of the step S1830 according to an embodiment of the present disclosure.

Step S2110 is an optimal UI search step. In this step, the user's requirements, work characteristics, the user's personal contextual information, and the other-person contextual information, etc. are considered in a comprehensive manner to find the most suitable UI for the user. In the search process, various UI layouts and design elements may be compared with each other, and a UI configuration optimized so that the user may intuitively perform the work may be determined, based on the comparing result. For example, the location of each element and the amount of information may be adjusted according to the user's skill level or experience.

Step S2120 is a searched UI-based design creation step. In this step, an actual design is created based on the optimal UI configuration determined in the step S2110. The created design is intuitively configured so that the user may easily understand and manipulate the UI, and the information necessary for performing the work is efficiently arranged in the UI. The design created at this step plays an important role in enhancing visual completeness and improving user experience.

Step S2130 is a step of creating a work card including the UI design. Based on the UI design designed in the step S2120, a work card required by the user is created. This work card intuitively displays a list of works that the user should perform and information necessary for each work, so that the user can easily check and proceed with the work. For example, the work card may include essential step-by-step work procedures and reference materials, and may include information tailored to the user's work experience.

Step S2140 is a providing step of a feedback about whether the user is satisfied or not with the created work card or UI. The created work card or UI is provided to the user, and the user may express satisfaction therewith through a feedback function included in the UI. This feedback is used to evaluate the adequacy and usability of the UI or work card, and when the user is not satisfied with the UI or work card, a correction may be made thereto accordingly. For example, when the feedback indicating that the user is not satisfied with the UI or work card is input, the layout or information arrangement thereof may be reviewed and an optimization step thereof may be additionally performed.

Step S2150 is a final work card creation step. A final work card is created based on the user's feedback collected in the step S2140. This final work card is created based on the UI optimized for the user and necessary information, so that the user may perform the work more efficiently. Since the final work card is provided in an improved state through user feedback, user satisfaction may be increased and work efficiency may be maximized.

FIG. 21 visually presents a process of creating and providing an optimal UI and an optimal work card based on the user feedback through the above series of steps, thereby showing a process in which the UI design supporting the user-customized work performance is efficiently performed.

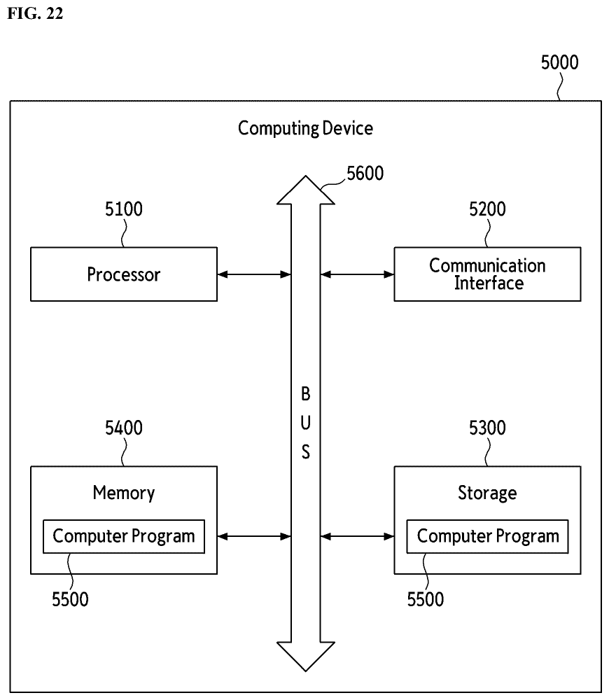

FIG. 22 is a block diagram illustrating a hardware configuration of a computing device for providing personalized work information according to an embodiment of the present disclosure.

Referring to FIG. 22, the computing device 5000 may include one or more processors 5100, a bus 5060, a communication interface 5200, a memory 5400 that loads a computer program executed by the processor 5100, and a storage 5300 that stores the computer program 5500. However, only components related to embodiments of the present disclosure are illustrated in FIG. 22. Therefore, one of ordinary skill in the art would understand that the computing device 5000 may further include other general-purpose components in addition to those illustrated in FIG. 22. In other words, the computing device 5000 may include various additional components beyond those shown in FIG. 22. Also, in some cases, the computing device 5000 may be configured with only a subset of the illustrated components. Hereinafter, each component of the computing device 5000 will be described. Throughout the present disclosure, the terms “computing device 5000” and “computing system” may be used interchangeably.

The processor 5100 may control the overall operations of the components of the computing device 5000. The processor 5100 may include at least one processor such as a Central Processing Unit (CPU), Micro Processor Unit (MPU), Micro Controller Unit (MCU), Graphic Processing Unit (GPU), or any other processor known in the art relevant to the present disclosure. The processor 5100 may perform computations for at least one application or program to execute operations or methods according to embodiments of the present disclosure. The computing device 5000 may include one or more processors.

The memory 5400 may store various data, commands, and/or information. The memory 5400 may load the computer program 5500 from the storage 5300 to execute operations or methods according to embodiments of the present disclosure. The memory 5400 may be implemented as a volatile memory such as RAM, although the present disclosure is not limited thereto.

The bus 5060 may provide communication capabilities between the components of the computing device 5000. The bus 5060 may be implemented in various forms, including an address bus, a data bus, and a control bus.

The communication interface 5200 may support wired or wireless Internet communication of the computing device 5000. Additionally, the communication interface 5200 may support various communication methods other than Internet communication. For this purpose, the communication interface 5200 may include a communication module known in the art relevant to the present disclosure.

The storage 5300 may non-temporarily store one or more computer programs 5500. The storage 5300 may include non-volatile memory such as Read-Only Memory (ROM), Erasable Programmable ROM (EPROM), Electrically Erasable Programmable ROM (EEPROM), flash memory, hard disk, removable disk, or any other computer-readable recording medium known in the relevant art.

The computer program 5500 may include one or more instructions that, when loaded into the memory 5400, cause the processor 5100 to perform operations or methods according to various embodiments of the present disclosure. That is, the processor 5100 may execute the loaded instructions to perform operations or methods according to various embodiments of the present disclosure.

For example, the computer program 5500 may include instructions to perform operations such as identifying, based on first information including task system data of a first user, a task list including a first task and at least one module required to perform the first task; generating, based on second information including the first user's experience, customized detailed information for the at least one module; and automatically generating a user-customized UI based on the task list, the at least one module, and the customized detailed information.

According to an embodiment of the present disclosure, the method and system may provide an optimized work performance environment based on individual user experience and proficiency using the personalized work recommendation AI platform. Unlike the conventional static and fixed work information providing scheme, the present disclosure provides the user-customized UI that is updated in real time with simultaneously considering of the user's personal contextual information (proficiency, past work experience, etc.) and the other-person contextual information (work progress of colleagues, decision-making information of teams, etc.). The method and system may select and provide the module suitable for each user and the necessary information for each user, thereby maximizing the efficiency of the work performance and reducing the problem that the user suffers from confusion due to unnecessary information.

First, the system and method according to the present disclosure may generate and provide the user-customized information to allow a user to receive information suitable for his or her skill level in the process of performing the work. For example, a basic procedure is omitted and only key information is summarized and provided to a highly skilled user, whereas information including more basic data and detailed descriptions is provided to a less skilled user to support the performance of the work. Accordingly, the user can focus on the work by receiving only information suitable for his or her ability and experience, thereby greatly improving the speed and accuracy of work execution. Such user-customized information provision may allow the user to exclude unnecessary information from the work process but focus on key information, thereby greatly contributing to increasing individual work efficiency.

In addition, the system and method according to the present disclosure may support a dynamic work environment by updating the UI based on user feedback in real time. When a user provides feedback while performing a work, the platform may immediately apply the feedback to the UI and the work card to modify the configuration of the UI and the work card based on the feedback, and thus may provide information and support continuously optimized according to the user's needs and changing work conditions. Accordingly, the user can quickly respond to changing work needs, and further can simultaneously increase the satisfaction and work accuracy through personalized work experience.

Another important effect of the present disclosure is that collaboration between users and work continuity may be greatly improved through real-time application of the other-person contextual information. For example, it may be assumed that a ‘market trend research’ work is assigned to a specific team project. In this case, when another member of the team has completed the work, the system may recognize this situation and exclude the work from the new user's to-do list or adjust the priority of the work. As a result, redundant work may be prevented, and users can focus on new work more effectively, thereby maximizing collaboration efficiency.

Furthermore, the system and method may provide information in consideration of the work flow of an entirety of an organization based on the other-person contextual information. For example, when a user A uploads data necessary for preparing for a work trip, this data may be automatically included in the UI of a user B and provided in real time to the user B. As a result, the time delay in data sharing and information delivery is reduced, and the user can quickly access the necessary data to further increase the speed of work processing. This has the effect of sharing data and enabling accurate delivery of information when necessary, thereby increasing the speed of information delivery and communication within the organization.

In this way, the real-time application of the other-person contextual information overcomes the limitations of conventional systems that rely only on individual user contextual information, and enables the implementation of a user-customized work platform suitable for a collaboration-oriented organizational environment. In particular, when a major decision-making matter of a specific project is updated, the same UI having the latest information based on the updated decision-making matter is provided to all relevant users, thereby preventing confusion that may occur during work and reducing communication errors between teams. As a result, users can make decisions based on consistent information, and the reliability and efficiency of collaboration within the organization is improved.

In conclusion, the personalized work recommendation AI platform of the present disclosure is configured to comprehensively apply the user experience, proficiency, and other people's work contexts to achieve the optimized information provision, and to execute the real-time feedback application function, thereby increasing the speed and accuracy of work processing and improving the reliability of the system. The personalized work recommendation AI platform of the present disclosure not only increases the operational efficiency of the organization, but also creates a user-friendly and flexible work environment to contribute to the improvement of the work productivity of the company. Thus, the personalized work recommendation AI platform of the present disclosure may become an innovative work platform that guarantees collaboration between teams, work continuity, and process consistency.

Although embodiments of the present disclosure have been described above with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above are not restrictive but illustrative in all respects.

Various embodiments of the present disclosure and their corresponding effects have been described above with reference to FIGS. 1 through 22. The technical effects of the present disclosure are not limited to those explicitly mentioned above, and other effects not expressly stated may be clearly understood by those of ordinary skill in the art based on the following description.

Although all components constituting the embodiments of the present disclosure have been described as being combined or operating together as one unit, the present disclosure is not necessarily limited to such embodiments. That is, within the scope and spirit of the present disclosure, the components may also be selectively combined in one or more groups and operate accordingly.

Although operations have been illustrated in a particular order in the figures, it should not be understood that the operations must be performed in the specific order shown, or in sequential order, or that all illustrated operations are required to obtain the desired results. In certain circumstances, multitasking or parallel processing may be advantageous. Furthermore, the separation of various components in the above-described embodiments should not be construed as requiring such separation, and it should be understood that the described program components and systems may generally be integrated together into a single software product or packaged into multiple software products.

While the embodiments of the present disclosure have been described above with reference to the accompanying drawings, it will be understood by those of ordinary skill in the art that the present disclosure may be implemented in other specific forms without departing from the spirit or essential characteristics thereof. Accordingly, the above-described embodiments are to be understood as illustrative in all respects and not limiting. The scope of the present disclosure should be interpreted based on the claims below, and all technical ideas falling within the scope of equivalence thereof should be interpreted as being included within the scope of the present disclosure.

What is claimed is:

1. A method for providing personalized work information, the method being performed by a computing device, wherein the method comprises:
identifying a work list including a first work, and at least one module necessary for performing the first work, based on first information including work system data of a first user;
generating user-customized detailed information on the at least one module, based on second information including experience of the first user; and
automatically creating a user-customized user interface (UI), based on the work list, the at least one module, and the user-customized detailed information.

2. The method of claim 1, wherein the work list and the at least one module are updated in real time based on update of the first information,
wherein the user-customized detailed information is updated in real time based on update of the second information.

3. The method of claim 1, wherein the first information further includes work system data of a second user different from the first user,
wherein the second information further includes experience of the second user different from the first user,
wherein the work list and the at least one module are updated in real time based on update of the first information,
wherein the user-customized detailed information is updated in real time based on update of the second information.

4. The method of claim 3, further comprising:
determining whether the user-customized UI needs to be updated based on the first information and the second information; and
upon determination that the user-customized UI needs to be updated, updating the user-customized UI.

5. The method of claim 1, wherein the identifying of the work list and the at least one module includes:
identifying the work list including the first work based on the first information;
checking whether a module related to the first work is required, based on the first information; and
identifying the at least one module necessary for performing the first work, based on the checking result.

6. The method of claim 1, wherein the generating of the user-customized detailed information on the at least one module includes:
analyzing the second information including the experience of the first user;
identifying the user-customized detailed information on the at least one module, based on the analyzing result; and
generating the identified user-customized detailed information.

7. The method of claim 1, wherein the automatically generating of the user-customized UI includes:
searching for an optimal UI;
creating a design based on the searched UI;
creating a first work card including the created design;
providing a feedback about whether the first user is satisfied with the first work card; and
creating a second work card based on the provided feedback.

8. A device for providing personalized work information, the device comprising:
at least one processor; and
a memory storing therein a computer program executed by the at least one processor,
wherein when the computer program is executed by the at least one processor, the computer program causes the at least one processor to:
identify a work list including a first work, and at least one module necessary for performing the first work, based on first information including work system data of a first user;
generate user-customized detailed information on the at least one module, based on second information including experience of the first user; and
automatically create a user-customized user interface (UI), based on the work list, the at least one module, and the user-customized detailed information.

9. The device of claim 8, wherein the work list and the at least one module are updated in real time based on update of the first information,
wherein the user-customized detailed information is updated in real time based on update of the second information.

10. The device of claim 8, wherein the first information further includes work system data of a second user different from the first user,
wherein the second information further includes experience of the second user different from the first user,
wherein the work list and the at least one module are updated in real time based on update of the first information,
wherein the user-customized detailed information is updated in real time based on update of the second information.

11. The device of claim 10, wherein when the computer program is executed by the at least one processor, the computer program causes the at least one processor to:
determine whether the user-customized UI needs to be updated, based on the first information and the second information; and
upon determination that the user-customized UI needs to be updated, update the user-customized UI.

12. The device of claim 8, wherein the identifying of the work list and the at least one module includes:
identifying the work list including the first work based on the first information;
checking whether a module related to the first work is required, based on the first information; and
identifying the at least one module necessary for performing the first work, based on the checking result.

13. The device of claim 8, wherein the generating of the user-customized detailed information on the at least one module includes:
analyzing the second information including the experience of the first user;
identifying the user-customized detailed information on the at least one module, based on the analyzing result; and
generating the identified user-customized detailed information.

14. The device of claim 8, wherein the automatically generating of the user-customized UI includes:
searching for an optimal UI;
creating a design based on the searched UI;
creating a first work card including the created design;
providing a feedback about whether the first user is satisfied with the first work card; and
creating a second work card based on the provided feedback.

15. A non-transitory computer-readable storage medium storing computer program, which is configured to be executed by a computing device to cause the computer device to:
identify a work list including a first work, and at least one module necessary for performing the first work, based on first information including work system data of a first user;
generate user-customized detailed information on the at least one module, based on second information including experience of the first user; and
automatically create a user-customized user interface (UI), based on the work list, the at least one module, and the user-customized detailed information.

16. The non-transitory computer-readable storage medium of claim 15, wherein the work list and the at least one module are updated in real time based on update of the first information,
wherein the user-customized detailed information is updated in real time based on update of the second information.

17. The non-transitory computer-readable storage medium of claim 15, wherein the first information further includes work system data of a second user different from the first user,
wherein the second information further includes experience of the second user different from the first user,
wherein the work list and the at least one module are updated in real time based on update of the first information,
wherein the user-customized detailed information is updated in real time based on update of the second information.

18. The non-transitory computer-readable storage medium of claim 17, wherein the computer program is further configured to be executed by the computer device to cause the computer device to:
determine whether the user-customized UI needs to be updated, based on the first information and the second information; and
upon determination that the user-customized UI needs to be updated, update the user-customized UI.

19. The non-transitory computer-readable storage medium of claim 15, wherein the identifying of the work list and the at least one module includes:
identifying the work list including the first work based on the first information;
checking whether a module related to the first work is required, based on the first information; and
identifying the at least one module necessary for performing the first work, based on the checking result.

20. The non-transitory computer-readable storage medium of claim 15, wherein the generating of the user-customized detailed information on the at least one module includes:
analyzing the second information including the experience of the first user;
identifying the user-customized detailed information on the at least one module, based on the analyzing result; and
generating the identified user-customized detailed information.
